(19) United States
(12) Patent Application Publication
(10) Pub. No.: US 2026/0141409 A1
(43) Pub. Date: May 21, 2026

(54) SYSTEMS AND METHODS FOR DYNAMIC DISCOVERY OF CONFIGURATION ITEMS AND RELATIONSHIPS

(71) Applicant: Automation Anywhere, Inc., San Jose, CA (US)

(72) Inventors: Purushottam AMRADKAR, Sammamish, WA (US); Antonio NUCCI, San Jose, CA (US); Muddu SUDHAKAR, Saratoga, CA (US); Christos TRYFONAS, Foster City, CA (US)

(21) Appl. No.: 19/046,964

(22) Filed: Feb. 6, 2025

Related U.S. Application Data
(60) Provisional application No. 63/550,855, filed on Feb. 7, 2024.

(51) Int. Cl. G06Q 30/0201; G06F 16/28

(52) U.S. Cl. CPC G06Q 30/0201; G06F 16/284

(57) ABSTRACT

Described herein are methods, systems, and media for deriving operational insights about customer infrastructure comprising (a) obtaining customer incident data reported by one or more customers, wherein the customer incident data is pre-encoded using one or more encoding techniques that are specific or unique to the one or more customers; and (b) using a decoder module to directly process the customer incident data to generate an output, wherein the output comprises a plurality of configuration item(s) (CIs) discovered, derived or extracted from the customer incident data.

### CROSS-REFERENCE

This application claims the benefit of U.S. Provisional Application No. 63/550,855, filed Feb. 7, 2024, which is hereby incorporated by reference in its entirety herein for all purposes.

### BACKGROUND

Generative artificial intelligence (AI) is artificial intelligence capable of generating text, images, or other media, using generative models. Advances in transformer-based deep neural networks have enabled a number of generative AI systems notable for accepting natural language prompts as input. One such type of model, a large language model (LLM), is a deep learning algorithm that can recognize, summarize, translate, predict and generate text and other forms of content based on knowledge gained from massive datasets. LLMs cans improve enterprise operations, making them more efficient, accurate, and personalized.

### SUMMARY

In one aspect, disclosed herein are computer-implemented methods for deriving operational insights about customer infrastructure, the method comprising: (a) obtaining customer incident data reported by one or more customers, wherein the customer incident data is pre-encoded using one or more encoding techniques that are specific or unique to the one or more customers; and (b) using a decoder module to directly process the customer incident data to generate an output, wherein the output comprises a plurality of configuration item(s) (CIs) discovered, derived or extracted from the customer incident data.

In some embodiments, the decoder module does not require processing of other data to generate the output comprising of the plurality of CIs. In some embodiments, the customer incident data is pre-encoded in a form of a configuration item (CI) string. In some embodiments, the CI string comprises a CI name and a set of CI attributes. In some embodiments, the set of CI attributes comprises a region, an environment, a type and/or an instance identifier associated with the CI. In some embodiments, the plurality of CIs in the output of the decoder module comprises the CI name and the set of CI attributes discovered, derived or extracted from the CI string. In some embodiments, the decoder module uses n-gram based string decoding using algebraic signatures to directly process the customer incident data. In some embodiments, the method further comprises using a CI relationships discovery module to group the plurality of CIs based at least in part on the environment(s) in which the CIs are deployed. In some embodiments, the CIs belonging to a same environment are grouped together to allow logical isolation of the plurality of CIs. In some embodiments, the method further comprises using the CI relationships discovery module to analyze temporal correlation of customer incidents, wherein time-correlated customer incidents are associated with corresponding CIs to be time-correlated. In some embodiments, the corresponding CIs to be time-correlated are indicative that said corresponding CIs are related. In some embodiments, the temporal correlation of customer incidents is analyzed using a micro epoch, wherein the micro epoch comprises a rolling time window in which the CI relationships discovery module tracks appearances of the customer incidents and the corresponding CIs. In some embodiments, the rolling time window is about 10 seconds. In some embodiments, a length of the micro epoch is set to ensure that the CI relationships discovery module focuses on discovery of highly correlated customer incidents and CIs. In some embodiments, the method further comprises using the CI relationships discovery module to track a direction of a relationship between time-correlated CIs. In some embodiments, the CI relationships discovery module is used to determine a CI correlation strength by computing a distribution of correlated CI pairs. In some embodiments, the method further comprises: automatically constructing a CI relationship graph and updating the CI relationship graph substantially in real-time using CI relationships discovered by the CI relationships discovery module.

In another aspect, disclosed herein are computer-implemented systems comprising at least one processor and instructions causing the at least one processor to perform operations for deriving operational insights about customer infrastructure, the system comprising: a decoder module configured to directly process customer incident data to generate an output, wherein the customer incident data is reported by one or more customers and is pre-encoded using one or more encoding techniques that are specific or unique to the one or more customers, and wherein the output comprises a plurality of configuration item(s) (CIs) discovered, derived or extracted from the customer incident data.

In some embodiments, the decoder module does not require processing of other data to generate the output comprising of the plurality of CIs. In some embodiments, the customer incident data is pre-encoded in a form of a configuration item (CI) string. In some embodiments, the CI string comprises a CI name and a set of CI attributes. In some embodiments, the set of CI attributes comprises a region, an environment, a type and/or an instance identifier associated with the CI. In some embodiments, the plurality of CIs in the output of the decoder module comprises the CI name and the set of CI attributes discovered, derived or extracted from the CI string. In some embodiments, the decoder module is configured to use n-gram based string decoding using algebraic signatures to directly process the customer incident data. In some embodiments, the system further comprises a CI relationships discovery module configured to group the plurality of CIs based at least in part on the environments in which the CIs are deployed. In some embodiments, the CI relationships discovery module is configured to group together CIs belonging to a same environment to allow logical isolation of the plurality of CIs. In some embodiments, the CI relationships discovery module is further configured to analyze temporal correlation of customer incidents, wherein time-correlated customer incidents are associated with corresponding CIs to be time-correlated. In some embodiments, the corresponding CIs to be time-correlated are indicative that said corresponding CIs are related.

In some embodiments, the temporal correlation of customer incidents is analyzed using a micro epoch, wherein the micro epoch comprises a rolling time window in which the CI relationships discovery module is configured to track appearances of the customer incidents and the corresponding CIs. In some embodiments, the rolling time window is about 10 seconds. In some embodiments, a length of the micro epoch is set to ensure that the CI relationships discovery module focuses on discovery of highly correlated customer incidents and CIs. In some embodiments, the CI relationships discovery module is further configured to track a direction of a relationship between time-correlated CIs. In some embodiments, the CI relationships discovery module is configured to determine a CI correlation strength by computing a distribution of correlated CI pairs. In some embodiments, the system further comprises: automatically constructing a CI relationship graph and updating the CI relationship graph substantially in real-time using CI relationships discovered by the CI relationships discovery module.

In yet another aspect, disclosed herein are one or more non-transitory computer-readable storage media encoded with instructions executable by one or more processors to provide an application for deriving operational insights about customer infrastructure, the application comprising: (a) obtaining customer incident data reported by one or more customers, wherein the customer incident data is pre-encoded using one or more encoding techniques that are specific or unique to the one or more customers; and (b) using a decoder module to directly process the customer incident data to generate an output, wherein the output comprises a plurality of configuration item(s) (CIs) discovered, derived or extracted from the customer incident data.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a non-limiting example of a computing device; in this case, a device with one or more processors, memory, storage, and a network interface, per one or more embodiments herein;

FIG. 2 shows a first diagram of an exemplary technology stack, per one or more embodiments herein;

FIG. 3 shows a second diagram of an exemplary technology stack; in this case, a technology stack with large language model (LLM) emphasis;

FIG. 4 shows a diagram of an exemplary method of prompt registration configured at an admin console through an LLM gateway, per one or more embodiments herein;

FIG. 5 shows a non-limiting example of a graphic user interface (GUI); in this case, a GUI for an admin console showing artificial intelligence (AI) service desk features;

FIG. 6 shows a non-limiting example of a GUI; in this case, a GUI for an admin console showing AI ops desk features;

FIG. 7 shows a non-limiting example of a GUI; in this case, a GUI for an admin console showing AI support intelligence features;

FIG. 8 shows a non-limiting diagram of exemplary functional blocks for decoding configuration item information from customer incident data using an n-Gram based string decoding;

FIG. 9 shows another non-limiting diagram of exemplary functional blocks for decoding configuration item information from customer incident data using natural language processing on customer incident titles and configuration item strings;

FIGS. 10A-10C show non-limiting examples of CI relationships discovery output in which a plurality of CI(s) is grouped by CI country and CI city;

FIG. 11A and FIG. 11B show non-limiting examples of CI relationships discovery output in which a plurality of CI(s) is grouped by CI environment;

FIGS. 12A-12D show non-limiting examples of CI relationships discovery output in which a plurality of CI(s) is grouped by CI business applications and services;

FIGS. 13A-13E show non-limiting examples of CI relationships discovery output in which a plurality of CI(s) is grouped by a self-operating CI decoder and a CMDB-assisted CI decoder;

FIG. 14 shows a non-limiting example of a CI relationship discovery module comprising a temporal lens-MI-CG (Major Incident Cohort Group);

FIG. 15 shows a non-limiting diagram of an exemplary CI discovery module relationship graph for a configuration item “Duo Security”;

FIG. 16 shows a non-limiting diagram of an exemplary CI discovery module relationship graph comprising a 1-tier dynamic service map;

FIG. 17 shows a non-limiting diagram of an exemplary CI discovery module relationship graph comprising a 2-tier dynamic service map for the CI “Duo Security”;

FIG. 18 shows a non-limiting diagram of an exemplary CI discovery module relationship graph, in this case, a CI relationship graph for a CI “Tibco-PRD”;

FIG. 19 shows a non-limiting diagram of an exemplary CI discovery module relationship graph comprising a 1-tier dynamic service map for configuration item “Tibco-PRD”;

FIG. 20 shows a non-limiting diagram of an exemplary CI discovery module relationship graph, in this case, a CI relationship graph for a CI “Salesforce”;

FIG. 21 shows a non-limiting diagram of an exemplary CI discovery module relationship graph, in this case, a 1-tier dynamic service map for a CI “Salesforce”;

FIG. 22 shows a non-limiting diagram of an exemplary CI discovery module relationship graph, in this case, a CI relationship graph for a CI “Marketo”; and

FIG. 23 shows a non-limiting diagram of an exemplary CI discovery module relationship graph, in this case, a 1-tier dynamic service map for a CI “Marketo.”

### DETAILED DESCRIPTION

Described herein, in certain embodiments, are computer-implemented methods for deriving operational insights about customer infrastructure, the method comprising: (a) obtaining customer incident data reported by one or more customers, wherein the customer incident data is pre-encoded using one or more encoding techniques that are specific or unique to the one or more customers; and (b) using a decoder module to directly process the customer incident data to generate an output, wherein the output comprises a plurality of configuration item(s) (CIs) discovered, derived or extracted from the customer incident data.

Also described herein, in certain embodiments, are computer-implemented systems comprising at least one processor and instructions causing the at least one processor to perform operations for deriving operational insights about customer infrastructure, the system comprising: a decoder module configured to directly process customer incident data to generate an output, wherein the customer incident data is reported by one or more customers and is pre-encoded using one or more encoding techniques that are specific or unique to the one or more customers, and wherein the output comprises a plurality of configuration item(s) (CIs) discovered, derived or extracted from the customer incident data.

Also described herein, in certain embodiments, are one or more non-transitory computer-readable storage media encoded with instructions executable by one or more processors to provide an application for deriving operational insights about customer infrastructure, the application comprising: (a) obtaining customer incident data reported by one or more customers, wherein the customer incident data is pre-encoded using one or more encoding techniques that are specific or unique to the one or more customers; and (b) using a decoder module to directly process the customer incident data to generate an output, wherein the output comprises a plurality of configuration item(s) (CIs) discovered, derived or extracted from the customer incident data.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount, in some cases near the stated amount by 10%, 5%, or 1%, including increments therein, and in some cases, in reference to a percentage, refers to an amount that is greater or less the stated percentage by 10%, 5%, or 1%, including increments therein.

As used herein, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Reference throughout this specification to “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics may be combined in any suitable manner in one or more embodiments.

### Computing Systems

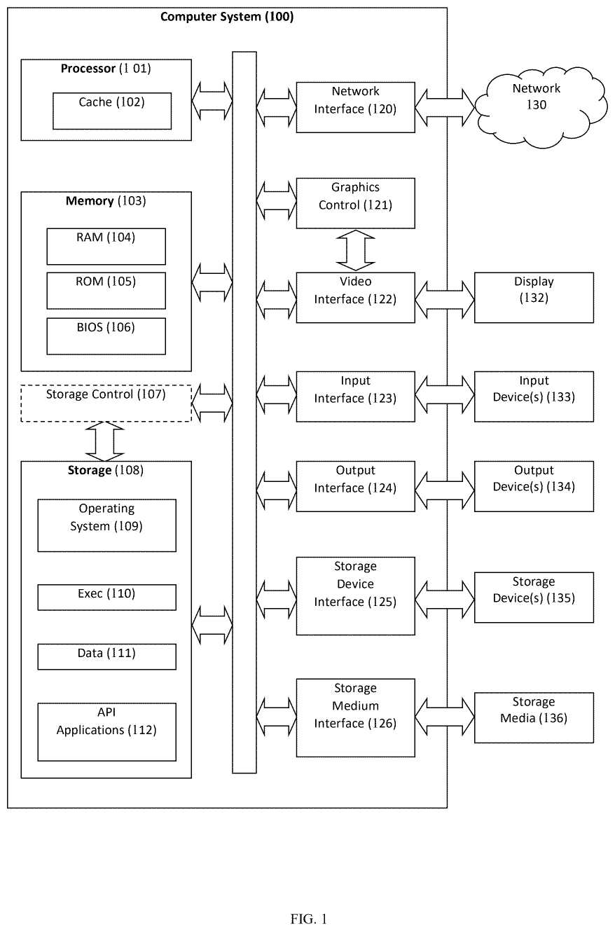

Referring to FIG. 1, a block diagram is shown depicting an exemplary machine that includes a computer system 100 (e.g., a processing or computing system) within which a set of instructions can execute for causing a device to perform or execute any one or more of the aspects and/or methodologies for static code scheduling of the present disclosure. The components in FIG. 1 are examples only and do not limit the scope of use or functionality of any hardware, software, embedded logic component, or a combination of two or more such components implementing particular embodiments.

Computer system 100 may include one or more processors 101, a memory 103, and a storage 108 that communicate with each other, and with other components, via a bus 140. The bus 140 may also link a display 132, one or more input devices 133 (which may, for example, include a keypad, a keyboard, a mouse, a stylus, etc.), one or more output devices 134, one or more storage devices 135, and various tangible storage media 136. All of these elements may interface directly or via one or more interfaces or adaptors to the bus 140. For instance, the various tangible storage media 136 can interface with the bus 140 via storage medium interface 126. Computer system 100 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 100 includes one or more processor(s) 101 (e.g., central processing units (CPUs) or general purpose graphics processing units (GPGPUs)) that carry out functions. Processor(s) 101 optionally contains a cache memory unit 102 for temporary local storage of instructions, data, or computer addresses. Processor(s) 101 are configured to assist in execution of computer readable instructions. Computer system 100 may provide functionality for the components depicted in FIG. 1 as a result of the processor(s) 101 executing non-transitory, processor-executable instructions embodied in one or more tangible computer-readable storage media, such as memory 103, storage 108, storage devices 135, and/or storage medium 136. The computer-readable media may store software that implements particular embodiments, and processor(s) 101 may execute the software. Memory 103 may read the software from one or more other computer-readable media (such as mass storage device(s) 135, 136) or from one or more other sources through a suitable interface, such as network interface 120. The software may cause processor(s) 101 to carry out one or more processes or one or more steps of one or more processes described or illustrated herein. Carrying out such processes or steps may include defining data structures stored in memory 103 and modifying the data structures as directed by the software.

The memory 103 may include various components (e.g., machine readable media) including, but not limited to, a random access memory component (e.g., RAM 104) (e.g., static RAM (SRAM), dynamic RAM (DRAM), ferroelectric random access memory (FRAM), phase-change random access memory (PRAM), etc.), a read-only memory component (e.g., ROM 105), and any combinations thereof. ROM 105 may act to communicate data and instructions unidirectionally to processor(s) 101, and RAM 104 may act to communicate data and instructions bidirectionally with processor(s) 101. ROM 105 and RAM 104 may include any suitable tangible computer-readable media described below. In one example, a basic input/output system 106 (BIOS), including basic routines that help to transfer information between elements within computer system 100, such as during start-up, may be stored in the memory 103.

Fixed storage 108 is connected bidirectionally to processor(s) 101, optionally through storage control unit 107. Fixed storage 108 provides additional data storage capacity and may also include any suitable tangible computer-readable media described herein. Storage 108 may be used to store operating system 109, executable(s) 110, data 111, applications 112 (application programs), and the like. Storage 108 can also include an optical disk drive, a solid-state memory device (e.g., flash-based systems), or a combination of any of the above. Information in storage 108 may, in appropriate cases, be incorporated as virtual memory in memory 103.

In one example, storage device(s) 135 may be removably interfaced with computer system 100 (e.g., via an external port connector (not shown)) via a storage device interface 125. Particularly, storage device(s) 135 and an associated machine-readable medium may provide non-volatile and/or volatile storage of machine-readable instructions, data structures, program modules, and/or other data for the computer system 100. In one example, software may reside, completely or partially, within a machine-readable medium on storage device(s) 135. In another example, software may reside, completely or partially, within processor(s) 101.

Bus 140 connects a wide variety of subsystems. Herein, reference to a bus may encompass one or more digital signal lines serving a common function, where appropriate. Bus 140 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 100 may also include an input device 133. In one example, a user of computer system 100 may enter commands and/or other information into computer system 100 via input device(s) 133. Examples of an input device(s) 133 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 133 may be interfaced to bus 140 via any of a variety of input interfaces 123 (e.g., input interface 123) including, but not limited to, serial, parallel, game port, USB, FIREWIRE, THUNDERBOLT, or any combination of the above.

In particular embodiments, when computer system 100 is connected to network 130, computer system 100 may communicate with other devices, specifically mobile devices and enterprise systems, distributed computing systems, cloud storage systems, cloud computing systems, and the like, connected to network 130. Communications to and from computer system 100 may be sent through network interface 120. For example, network interface 120 may receive incoming communications (such as requests or responses from other devices) in the form of one or more packets (such as Internet Protocol (IP) packets) from network 130, and computer system 100 may store the incoming communications in memory 103 for processing. Computer system 100 may similarly store outgoing communications (such as requests or responses to other devices) in the form of one or more packets in memory 103 and communicated to network 130 from network interface 120. Processor(s) 101 may access these communication packets stored in memory 103 for processing.

Examples of the network interface 120 include, but are not limited to, a network interface card, a modem, and any combination thereof. Examples of a network 130 or network segment 130 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 130, may employ a wired and/or a wireless mode of communication. In general, any network topology may be used.

Information and data can be displayed through a display 132. Examples of a display 132 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 132 can interface to the processor(s) 101, memory 103, and fixed storage 108, as well as other devices, such as input device(s) 133, via the bus 140. The display 132 is linked to the bus 140 via a video interface 122, and transport of data between the display 132 and the bus 140 can be controlled via the graphics control 121. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 132, computer system 100 may include one or more other peripheral output devices 134 including, but not limited to, an audio speaker, a printer, a storage device, and any combinations thereof. Such peripheral output devices may be connected to the bus 140 via an output interface 124. Examples of an output interface 124 include, but are not limited to, a serial port, a parallel connection, a USB port, a FIREWIRE port, a THUNDERBOLT port, and any combinations thereof.

In addition or as an alternative, computer system 100 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, cloud computing platforms, distributed computing platforms, server clusters, server computers, desktop computers, laptop computers, notebook computers, sub-notebook computers, netbook computers, and netpad computers.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research in Motion® BlackBerry OS®, Google® Android®, Microsoft® Windows Phone® OS, Microsoft® Windows Mobile® OS, Linux®, and Palm® WebOS®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Programs

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, which perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of information, for example customer incident data. In various embodiments, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

### LLM Technology Stack

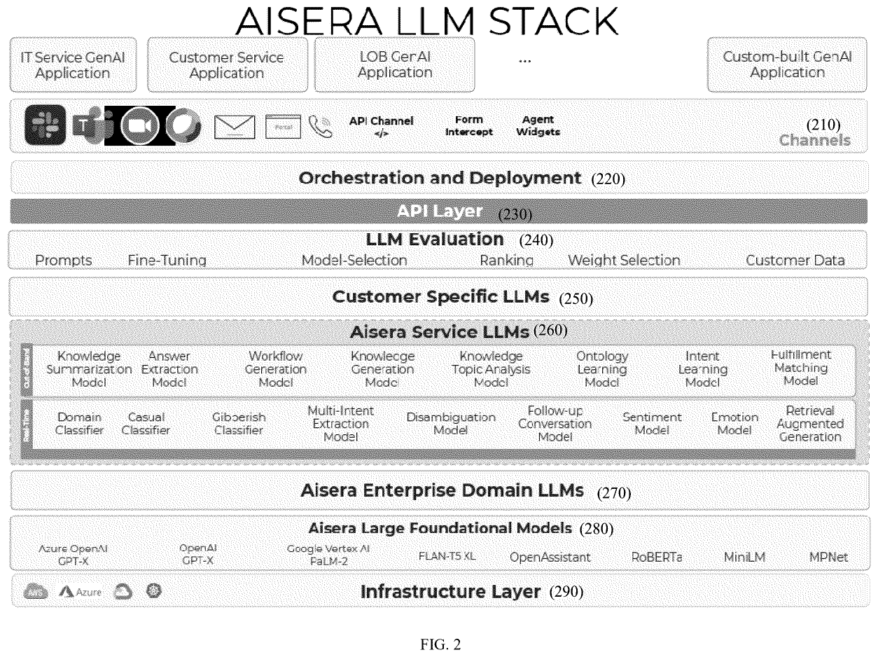

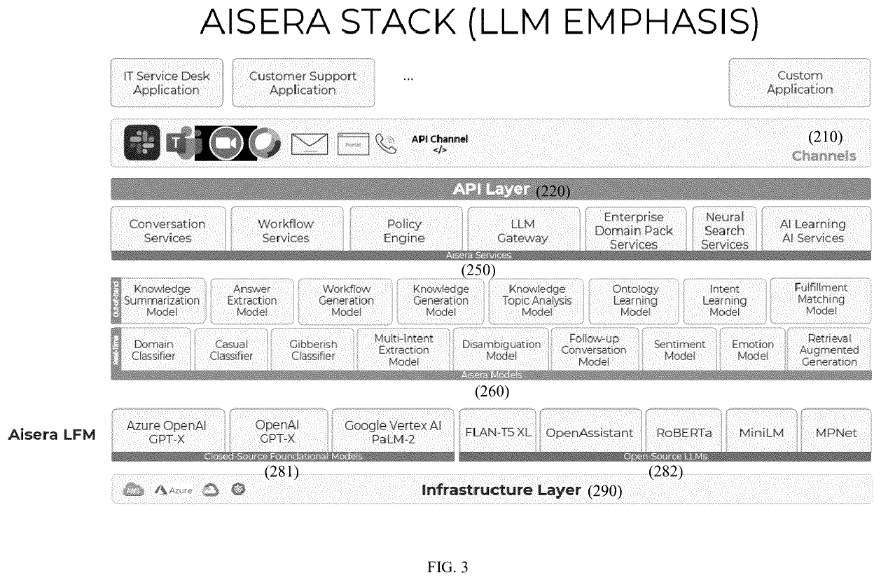

FIGS. 2 and 3 show diagrams of an exemplary Large Language Model (LLM) Technology Stack. In some embodiments, the LLM stack herein can be deployed, scaled and operated both in public clouds (AWS, GCP, Azure, etc.) on an Infrastructure Layer 290 and locally (on-premises) using the Kubernetes container orchestration platform.

In some embodiments, the LLM stack herein embeds a plurality of large foundational models (LFMs) 280, including both closed-source LFMs 281 via an API layer 230 integrated with LFMs, and open-source LFMs 282 via the LFM deployment and execution in secure Kubernetes containers. Non-limiting examples of closed-source LFM providers which are integrated with The LLM stack herein via APIs are Azure OpenAI (complete and chat APIs for GPT-3, GPT-3.5, and GPT-4), OpenAI (complete and chat APIs for GPT-3, GPT-3.5 and GPT-4), Google Vertex AI (PaLM-2). Non-limiting examples of open-source LFM are FLAN-T5, OpenAssistant, ROBERTa, MiniLM, and MPNet.

In some embodiments, the LLM stack herein enables a developer to choose from a pool of supported LFM/LLM models using a catalog, or to integrate a new LFM/LLM model using the LLM Gateway. In some embodiments, the LLM Gateway Toolkit allows the developer to select the LFM provider of choice, either from a catalog or by selecting “New LFM” (in which case he needs to provide the LFM Provider URL and the API Credentials to establish a successful connection), create a new LLM Group, which is a logical folder associated to the developer, and simply upload the new LLM models in the LLM group.

The LLM stack herein provides the developer with the flexibility of choosing both the LFM framework and a customer-specific LLM model 250 for any given task based on the different LLM services needed to operate a conversational AI assistant. As a result, in some embodiments, developers can develop end to end LLM workflows or LLM services 260 which comprise more than one task by choosing a specific LFM/LLM model for each specific task to be executed in the pipeline.

In some embodiments, developers can calibrate each model per their objectives to deliver a high level of precision and accuracy. In some embodiments, LLM stack herein allows the developer to calibrate the mode using the below behaviors:
Zero-shot Learning: The developer can use the pre-trained LLM model as-is. Examples of such tasks are language detection, language translation, sentiment detection, emotion detection, etc.
Few-shots Learning (e.g., prompt engineering or inference-time tuning): In some embodiments, the developer guides the model to the desired output by providing the LLM model with few examples and instructions. In some embodiments, this calibration model does not alter the underlying parameters of the LLM models.
Instruction-based Fine-Tuning: This method may provide a higher level of precision and accuracy than zero-shot or few-shot learnings. In some embodiments, in this method, the developer trains the model using specialized datasets, which are high-quality human-generated prompt/response pairs specifically designed for instruction tuning LLMs. In some embodiments, this method of calibration acts deeper in the LLM model by updating the internal parameters used by the model. The model fine-tuning is the most advanced calibration method and may require both computing resources for training and supervised, high-quality and extensive datasets to generate the prompt/response sentence pairs for training.

In some embodiments, the Large Language Model (LLM) technology stack herein can operate in multiple industry verticals (e.g., logistics, healthcare, wealth management, retailers, banking, airlines, and insurance) and enterprise domains 270 (e.g., IT, HR, legal and compliance, finance, supply chain management, facilities). The Enterprise Domain LLMs are LLM models which have been extensively fine-tuned using prompt/response sentence pairs extracted from Enterprise Domain Packs (EDPs). In some embodiments, each Enterprise Domain Pack comprises a domain-specific ontology, which is an extensive set of entity classes, entity names, entity synonymous like entity expansions, and abbreviations (initialisms, acronymous, shortenings and contractions) and domain-specific taxonomy, which is an extensive set of intents (and intent phrases) associated to each entity of the ontology. Each domain EDP may comprise hundreds of thousands to millions of intent phrases.

In some embodiments, the Large Language Model (LLM) technology stacks herein use pre-packaged and fine-tuned a large pool of domain-specific LLM Services 260 using one or more EDPs. The LLM Services 260 may be available to developers in a Service LLM catalog. In some embodiments, the developer uses the LLM Services 260 via an API or can select or drag/drop/chain them into a conversational workflow using a studio to build complete experiences around a service.

In some embodiments, the LLM stack herein provides a further level of LLM model customization beyond the calibration offered via the instruction-fine tuning and EDP. The Large Language Model (LLM) technology stack herein offers special learning pipelines, which act on the specific customer datasets (e.g., tickets, knowledge articles, call transcripts, etc.) which may automatically extract entities and intents which are very specific to the customer (e.g., within the domain of operation). In some embodiments, this custom-specific knowledge is then used to generate custom-specific prompt/responses which may then be used to execute a second round of instruction-based fine tuning on a proprietary Enterprise Domain LLMs, which may be fine-tuned using only the domain-specific EDPs. Exemplary proprietary AI Learning pipelines directly linked to instruction-based fine-tuning pf LLM models are listed below:
Tickets Learning Pipeline: Iteratively and continuously processes tickets and automatically extracts the main entities and associated intents. By grouping tickets tagged with the same pair of intents and entities, the pipeline may automatically generate intent phrases capturing the language diversity used by the specific customer to express the same concept.
Conversation Learning Pipeline: Iteratively and continuously processes user requests and calls transcripts, and automatically extracts the main entities and associated intents. By grouping conversations tagged with the same pair of intent and entity, the pipeline may automatically generate intent phrases capturing the language diversity used by the specific customer to express the same concept.
Knowledge Learning Pipeline: Processes ingested customer knowledge articles and may automatically extract the main entities, associated intents and large set of intent phrases from each article.
Ontology Generation: Consumes all the entity-based learning from the different pipelines, may automatically discover expansions, abbreviations, and relationships among the entities, and organizes all the entities into an ontology graph which may be made available as a catalog.
Taxonomy Generation: Consumes all the intent-based learning from the different pipelines and may automatically organize all semantic similar intents into a multi-category multi-level intent taxonomy which is made available as a catalog.

In some embodiments, the LLM stack herein provides an LLM evaluation level 240, which the user with a set of toolkits and APIs that developers can use to evaluate the performance of the LLM models herein. Developers can access toolkits and APIs for development, testing and benchmarking the following: prompt engineering (e.g., few shots learning), fine tuning, Model Selection via LLM catalog and LLM Gateway, model performance ranking which automatically scores the models against the same dataset to automatically stack rank LFM/LLM models based on the accuracy achieved, and manage customer datasets for instruction-fine tuning models.

In some embodiments, the LLM stack herein offers a comprehensive Orchestration and Deployment Layer 220 that is used to allocate and deploy resources (including servers, virtual machines, networking, security and storage), monitor software lifecycle operations, and recover from error conditions. In some embodiments, the LLM stack herein offers a large diversity of channels 210 to interface with users like Slack, Microsoft Teams, Cisco WebEx, Zoom, SMS/MMS, Email and Voice), Administrator Portal, Form Intercept and Agent Widgets.

In some embodiments, prompts can have a separate LLM Provider, internal or external (e.g., OpenAI, Bard, etc.). Input Variables can be passed into prompts (e.g., Chat history). In some embodiments, prompt groups and/or prompt chaining is implemented as well.

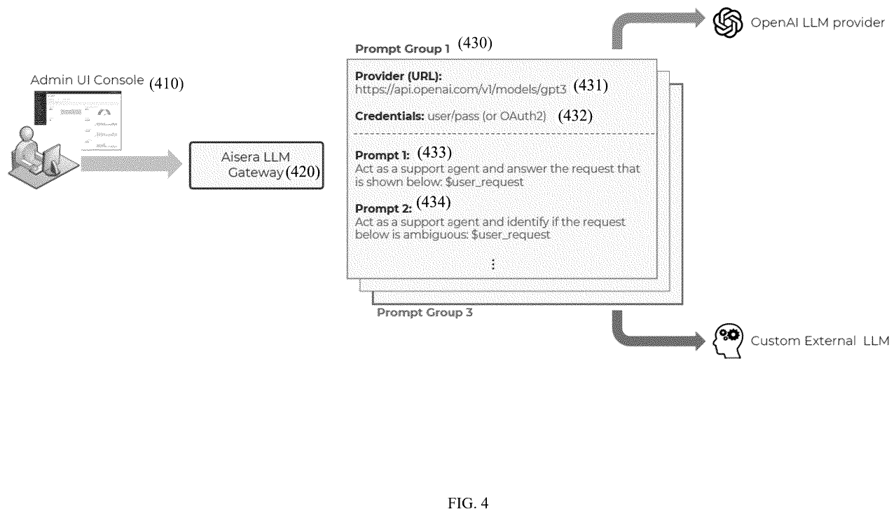

In some embodiments, per FIG. 4, an LLM provider is registered through a LLM Gateway by an Admin UI console 410. In some embodiments, prompts are added that will be used mainly for preconfigured Tasks through the LLM Gateway 420 (e.g., an Admin UI console). In some embodiments, calling the registered prompts can be performed by using a prompt for the main NLU path by inserting them inside the Pre-Handling Flow, or as an auxiliary capacity, by adding prompts inside a flow (e.g., using the new LLM action). In the example shown, a first prompt group 430 comprises a provider URL 431 and the associated credentials 432, a first prompt 433, and a second prompt 434. As shown, the first prompt 433 and the second prompt 434 of the first prompt group 430 are sent to an OpenAI LLM provider 450. Further, a second prompt group 440 is sent based on its provider URL (not shown), to a custom external LLM 460. In some embodiments, the LLM Gateway 420 determines, based on the prompt, the provider URL 431, the associated credentials 432, or any combination thereof whether to send the prompt to the OpenAI LLM provider 450 or to the custom external LLM 460. In some embodiments, the LLM Gateway 420 sends the prompt to the OpenAI LLM provider 450 for general prompts that can be answered by the OpenAI LLM provider 450. In some embodiments, the LLM Gateway 420 sends prompts specific to an organization, an application, or other specialized department to the custom external LLM 460.

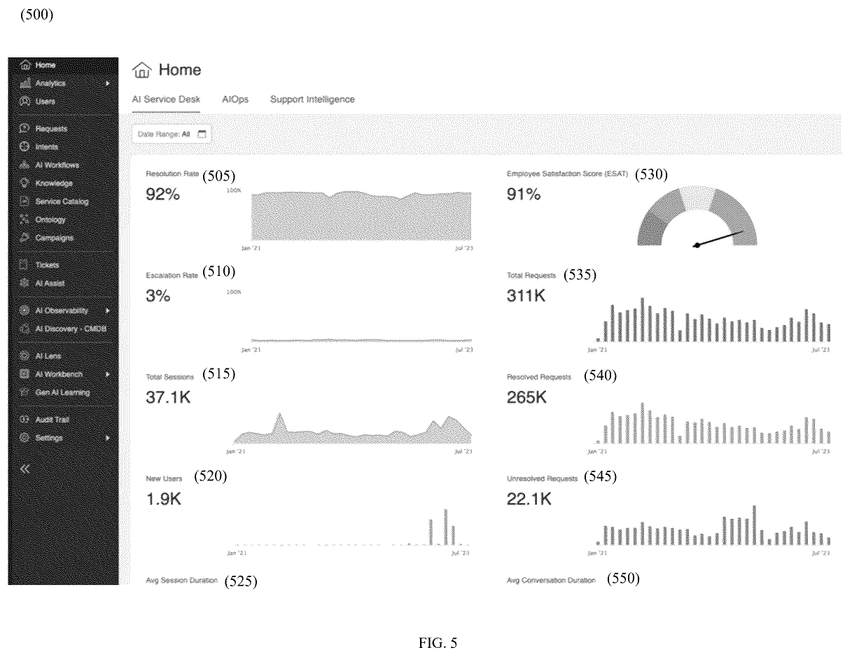

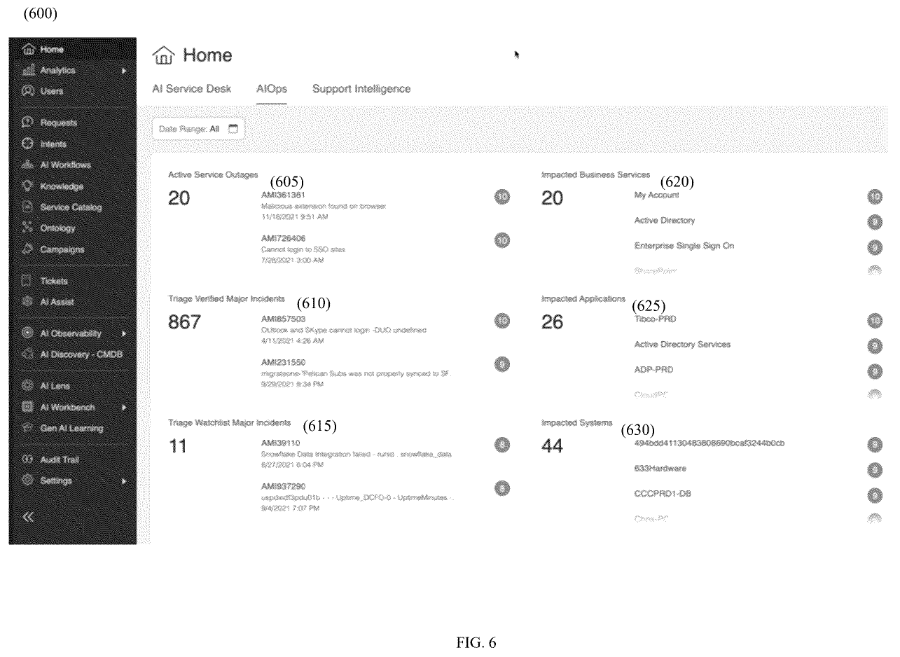

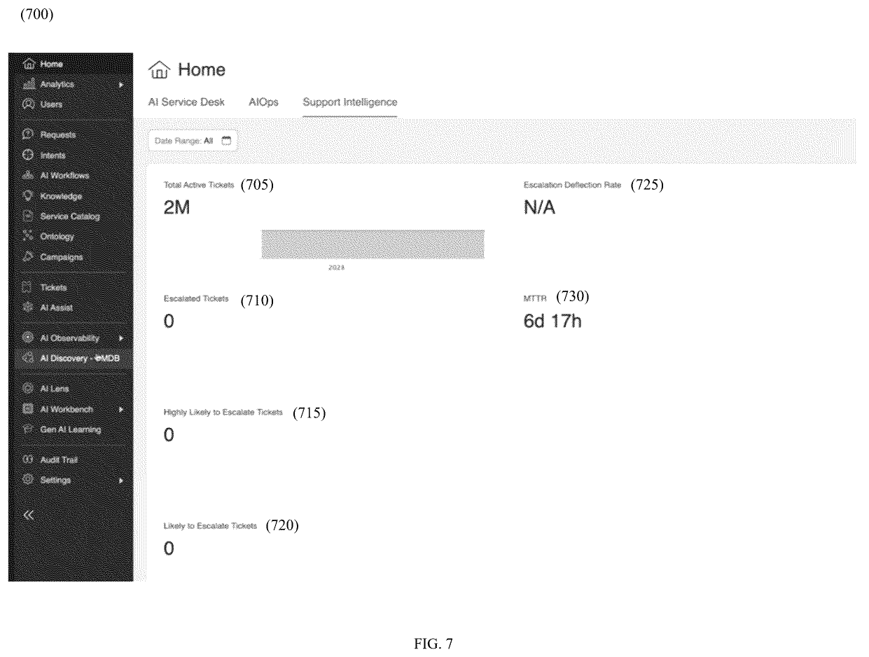

In some embodiments, technology stack described herein includes an administrative (or admin) console. In further embodiments, the admin console includes a front-end interface, such as a GUI. In still further embodiments, the GUI includes features allowing an admin user to review and configure features of the technology described herein. By way of example, in some embodiments, per FIG. 5, a GUI for an admin console 500 includes navigation elements allowing a user to access, by way of examples, analytics, users, requests, intents, AI workflows, knowledge bases, service catalogs, ontologies, campaigns, tickets, AI assist, AI observatory, AI discovery, AI lens, AI workbench, gen AI learning, an audit trail, and settings. Further, in some embodiments, per FIG. 5, a GUI for an admin console 500 includes an AI service deck feature providing access to data pertaining to, for example, resolution rates 505, escalation rates 510, total sessions 515, new users 520, average session duration 525, employee satisfaction score 530, total requests 535, resolved requests 540, unresolved requests 545, and average conversation duration 550. By way of further example, in some embodiments, per FIG. 6, a GUI for an admin console 600 includes an AI ops feature providing access to data pertaining to, for example, active service outages 605, triage verified major incidents 610, triage watchlist major incidents 615, impacted business services 620, impacted applications 625, and impacted systems 630. By way of still further example, in some embodiments, per FIG. 7, a GUI for an admin console 700 includes an support intelligence feature providing access to data pertaining to, for example, total active tickets 705, escalated tickets 710, highly likely to escalate tickets 715, likely to escalate tickets 720, escalation deflection rate 725, and mean time to recovery, repair, respond, or resolve (MTTR) 730.

### Overview

Described herein are artificial intelligence (AI) modules comprising a decoder module and a Configuration Item (CI) relationships discovery module.

The decoder module and the CI relationships discovery module described herein can be configured to provide users with visibility into Configuration Items (CI), for deriving operational insights about the wellness of customer infrastructure (e.g., hardware and software), systems, business services and applications. In some cases, a plurality of CIs comprising a customer network are stored into a CI database, for example, a Configuration Item Management Data Base (CMDB). In some instances, the plurality of CIs and their relationships may change over time (e.g., device addition, deletion, migration, etc.). Furthermore, in some instances, the CMDB can be updated at regular intervals to track the plurality of CIs and their relationships change over time Functional component modules may include, by way of non-limiting examples:

### I. Configuration Item Decoder Module.

The platforms, systems, media, and methods disclosed herein may comprise using a decoder module (e.g., referred to interchangeably as a CI decoder module). In some cases, the CI decoder module is configured to dynamically discover CI items. In some instances, the CI decider module is configured to directly process the customer incident data to generate a CI decoder output. In some cases, the CI decoder output comprises a plurality of configuration item(s) (CIs) discovered, derived or extracted from the customer incident data. In some cases, the decoding comprises decoding directly from the CI strings.

In some embodiments, the platforms, systems, media, and methods disclosed herein may comprise obtaining customer incident data reported by one or more customers. In some cases, the customer incident data comprises a plurality of customer incidents.

In some cases, the customer incident data is pre-encoded using one or more encoding techniques that are specific or unique to the one or more customers. In some cases, the decoder module does not or need not require processing of other types of data to generate the output comprising of the plurality of CI(s).

The decoder module disclosed herein can be configured to process customer incident data. In some examples, the customer incident data is pre-encoded using one or more encoding techniques that are specific or unique to the one or more customers. In some further embodiments, the decoder module is configured to generate the output comprising of the plurality of CI(s) based on the customer incident data.

In some cases, the customer incident data is pre-encoded in a form of a configuration item (CI) string. In some instances, the CI string comprises a CI name and a set of CI attributes. For example, the set of CI attributes may comprise a region, an environment, a type and/or an instance identifier associated with the CI. In further examples, the plurality of CI(s) in an output of the decoder module may comprise the CI name and the set of CI attributes discovered, derived or extracted from the CI string.

In other examples, the decoder module may process a CI string to generate the output comprising of the plurality of CIs.

In some cases, the CI decoder module is configured to learn directly from customer incident data. In some instances, the CI decoder module is configured to learn directly from customer incident titles. In some instances, the CI decoder module is configured to learn directly from CI strings.

In some cases, the CI decoder module is configured to auto-decode (e.g., automatically decode) CI meta attributes directly from CI strings. In some instances, the CI decoder module is configured to auto-decode CI meta attributes directly from CI strings attached to customer incident titles. For example, the meta attributes may be configured for fine-grain correlation, aggregation, filtering, or a combination thereof.

In some cases, the CI decoder module is configured to perform CI string processing on customer incident titles. In some instances, the CI decoder module is configured to perform CI string processing and natural language processing (NLP) on customer incident titles. For example, the CI decoder module may be configured to operate on CI strings and customer incident titles derived from data center (DC) and cloud environments.

In some cases, the customer incidents comprise a customer incident title, CI string, device information, performance information, and other attributes associated with the customer incident. In some instances, the customer incident reports at least one encoded CI. For example, the CI encoding may capture the CI region, CI environment, CI type, CI instance, or any combination thereof.

In some cases, the CI decoder module comprises an algorithm that directly processes the customer incident data. In some instances, the algorithm comprises an n-gram based string decoding using algebraic signatures to directly process the customer incident data.

Referring to FIG. 8, in some embodiments, an exemplary functional blocks and information flow 800 is provided for decoding configuration item information from customer incident data. In some cases, the CI decoder module uses n-gram based string decoding using algebraic signatures to directly process the customer incident data.

In the example of FIG. 8, the CI decoder module 801 receives a plurality of customer incident data 802. Furthermore, the plurality of customer incident data 802 comprises CI strings 803 (e.g., pre-encoded using one or more encoding techniques that are specific or unique to the one or more customers). In FIG. 8, the CI decoder module 801 directly processes the plurality of customer incident data 802 and generates an output 804. In FIG. 8, the output 804 comprises a plurality of configuration item(s) (CIs) discovered, derived or extracted from the customer incident data 802. For example, the output 804 comprises a CI region 805, CI environment 806, CI type 807, and CI instance 808.

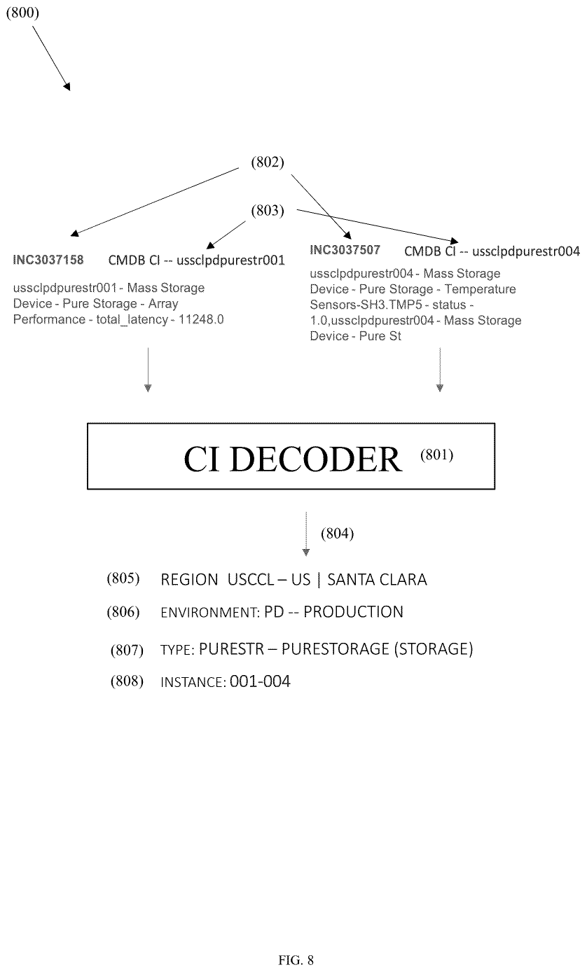

FIG. 9 shows another non-limiting diagram of exemplary functional blocks for decoding configuration item information from customer incident data using natural language processing on customer incident titles and configuration item strings.

In the example of FIG. 9, the CI decoder module 901 receives a plurality of customer incident data 902. Furthermore, the plurality of customer incident data 902 comprises CI strings 903 (e.g., pre-encoded using one or more encoding techniques that are specific or unique to the one or more customers). In FIG. 9, the CI decoder module 901 directly processes the plurality of customer incident data 902, for example using a natural language processing (NLP) model. Furthermore, in FIG. 9, the NLP model comprises a title decoding tokenization module 909 and a Name Entity Recognition (NER) model 910. In some instances the NER module 910 processes customer incident data via a database (e.g., CMDB) ontology. In some instances, the NER 910 is configured to receive an input CI Name Encoded (e.g., such as PURESTR). For example, the NER 910 may be configured to output 904 a name (e.g., such as PURESTR=PURESTORAGE).

In the example of FIG. 9, the CI decoder module 901 generates an output 904. In FIG. 9, the output 904 comprises a plurality of configuration item(s) (CIs) discovered, derived or extracted from the customer incident data 902. For example, the output 904 comprises a CI region 905, CI environment 906, CI Name 907, and CI instance 908. In further embodiments, the CI output may comprise parameters related to tokenization, model architecture, learning rate, or other hyperparameters that impact the model's performance. In even further embodiments, adjusting these CI(s) may permit users to fine-tune the AI system for their specific needs.

### II. Configuration Item Relationships Discovery Module.

The platforms, systems, media, and methods disclosed herein may comprise using a CI relationships discovery module. In some cases, the CI relationships discovery module is configured to receive CI titles and CI dynamic attributes. In some cases, the CI relationships discovery module is configured to generate a dictionary, wherein the dictionary comprises a log of terms extracted from the CI(s). In some instances, the CI relationships discovery module is configured to use the dictionary to filter/group customer incidents. In some cases, the CI relationships discovery module is configured to use dynamic CI methodology to assess an impact to Major Incident (MI) Creation and MI Cohort Creation. In some instances, the major incident comprises a major incident of CI(s). For example, a major incident of CI(s) may comprise a plurality of CI(s) associated to a customer network, business application, or other hardware, software, IT infrastructure, etc. In further examples, the plurality of CI(s) are associated to a business application, customer network that has experienced a significant disruption or breakdown. In some instances, the MI Cohort creation comprises a grouping of a MI (major incident) CI(s). For example, the MI Cohort may comprise the plurality of CI(s) associated to a business application, customer network that has experienced a significant disruption or breakdown.

In some cases, the CI relationships discovery module is configured to group the plurality of CI(s). In some instances, the CI relationships discovery module is configured to group the plurality of CI(s) based on a set of CI attributes. For example, the set of CI attributes may comprise a region, an environment, a type and/or an instance identifier associated with the CI.

In some cases, the CI relationships discovery module is configured to group the plurality of CI(s) based at least in part on the environment(s) in which the CIs are deployed.

In some cases, the CI(s) belonging to a same environment are grouped together to allow logical isolation of the plurality of CI(s).

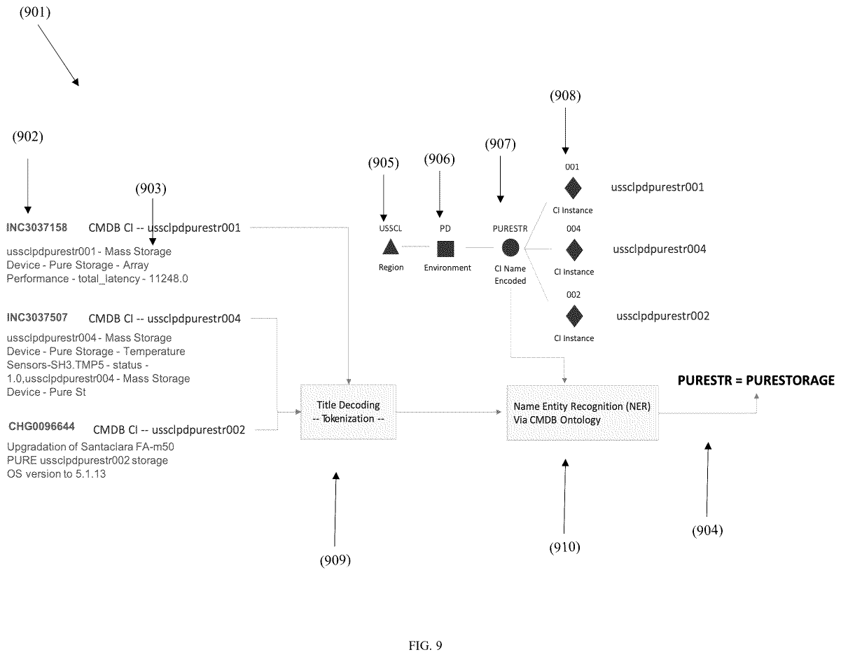

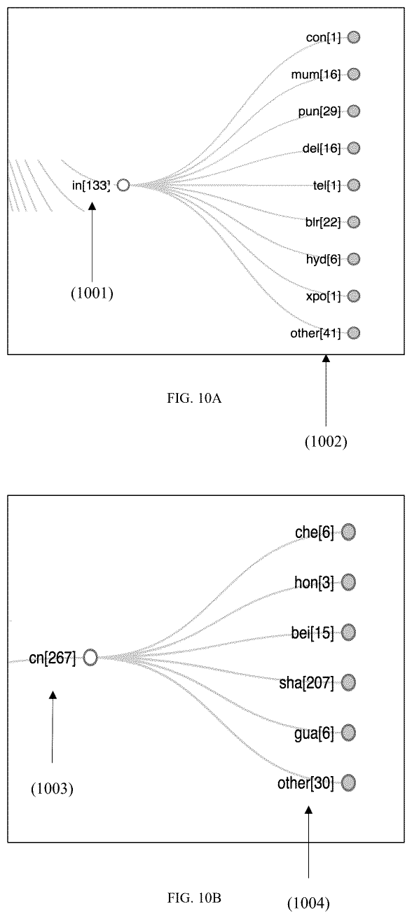

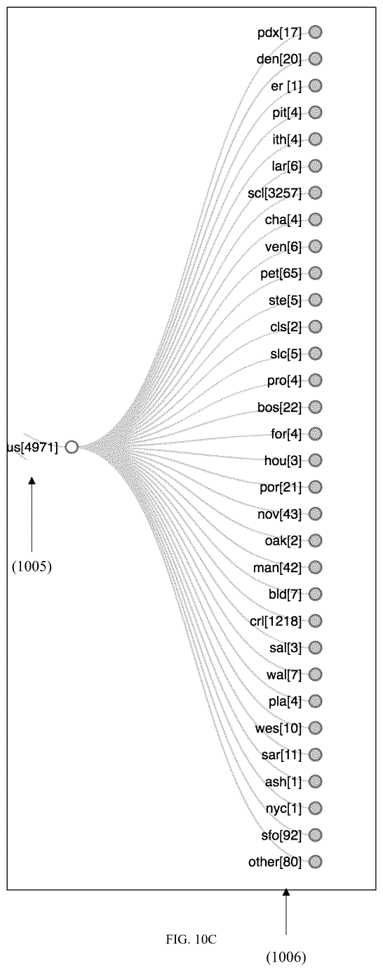

FIGS. 10A-10C show non-limiting examples of CI relationships discovery output in which a plurality of CI(s) is grouped by CI country and CI city. In the example of FIG. 10A, the plurality of CI(s) is grouped into a first group 1001. In FIG. 10A, the first group 1001 comprises a plurality (e.g., 133) of CI(s). Furthermore, each of the 133 CI(s) comprises a same country code “in” (e.g., India). In the example of FIG. 10A, each of the 133 CI(s) comprising the “in” country code are further grouped into a second plurality of groups 1002. In FIG. 10A, the second plurality of groups 1002 comprises a plurality of CI(s) organized by city code. For example, within the 133 CI(s) of the first group 1001 “in” there are 16 CI(s) comprising the city code “mum” (e.g., Mumbai).

In the example of FIG. 10B, the plurality of CI(s) is grouped into a first group 1003. In FIG. 10B, the first group 1003 comprises a plurality (e.g., 267) CI(s). Furthermore, each of the 267 CI(s) comprises a same country code “cn” (e.g., China). In the example of FIG. 10B, each of the 267 CI(s) comprising the “cn” country code are further grouped into a second plurality of groups 1004. In FIG. 10B, the second plurality of groups 1004 comprises a plurality of CI(s) organized by city code. For example, within the 267 CI(s) of the first group 1003 “in” there are 15 CI(s) comprising the city code “bei” (e.g., Beijing).

In the example of FIG. 10C, the plurality of CI(s) is grouped into a first group 1005. In FIG. 10B, the first group 1005 comprises a plurality (e.g., 4971) CI(s). Furthermore, each of the 4971 CI(s) comprises a same country code “us” (e.g., United States). In the example of FIG. 10C, each of the 4971 CI(s) comprising the “us” country code are further grouped into a second plurality of groups 1006. In FIG. 10C, the second plurality of groups 1006 comprises a plurality of CI(s) organized by city code. For example, within the 4971 CI(s) of the first group 1004 “us” there are 22 CI(s) comprising the city code “bos” (e.g., Boston).

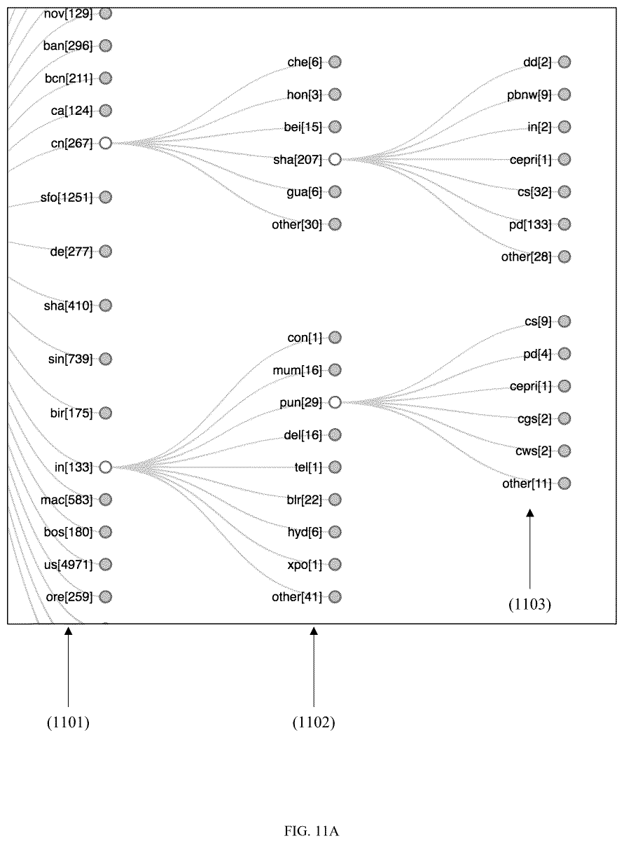

FIGS. 11A and 11B show non-limiting examples of CI relationships discovery output in which a plurality of CI(s) is grouped by CI environment. In the example of FIG. 11A, the plurality of CI(s) is grouped into a first plurality of CI groups 1101. For example, in FIG. 11A, the first plurality of CI groups 1101 comprises group “cn[267]” and group “in[133].” In the example of FIG. 11A, the first plurality of CI groups 1101 is grouped into a second plurality of CI groups 1102. For example, in FIG. 11A, the second plurality of CI groups 1102 comprises group “sha[207]” and group “pun[29].” In the example of FIG. 11A, the second plurality of CI groups 1102 are grouped into a third plurality of CI groups 1103. For example, in FIG. 11A, the third plurality of CI groups 1103 comprises group “in[2] and group “pd[4].”

FIG. 11B shows a non-limiting example of CI relationships discovery output; in this case, a plurality of CI(s) is grouped by CI environment. In the example of FIG. 11B, the plurality of CI(s) is grouped into a first plurality of CI groups 1104. For example, in FIG. 11B, the first plurality of CI groups 1104 comprises group “scl[3257]” and group “bos[22]” and group “crl[1218].” In the example of FIG. 11B, the first plurality of CI groups 1104 is grouped into a second plurality of CI groups 1105. For example, in FIG. 11B, the second plurality of CI groups 1105 comprises group “qd[201]” group “pd[2]” and group “pe[384].”

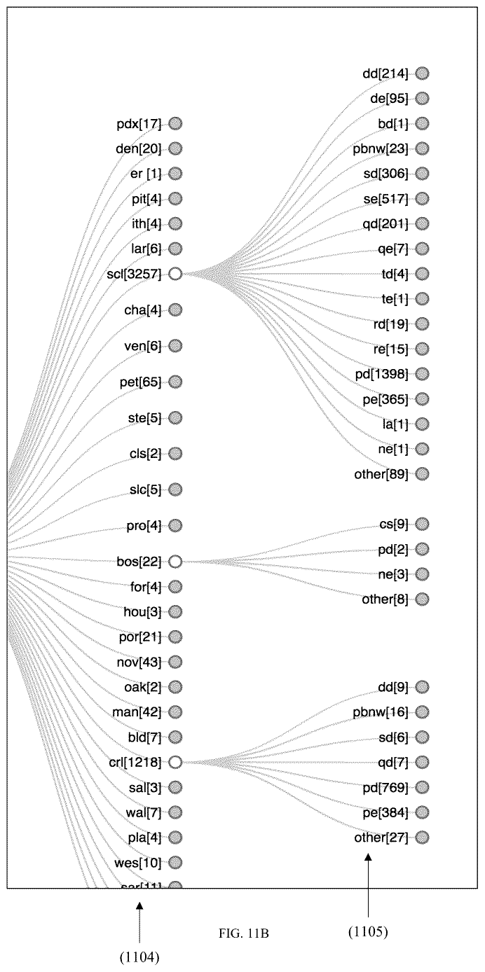

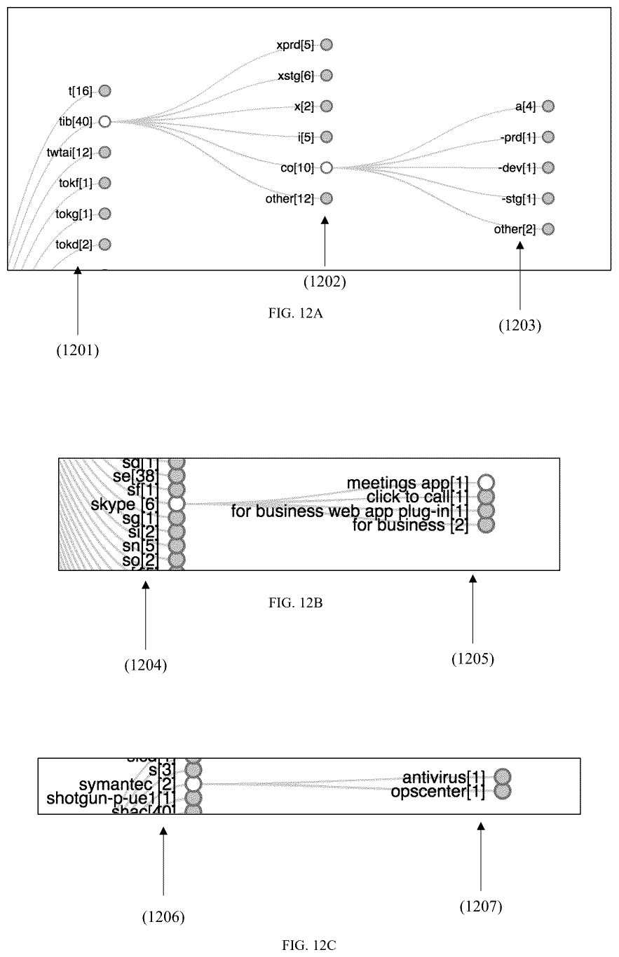

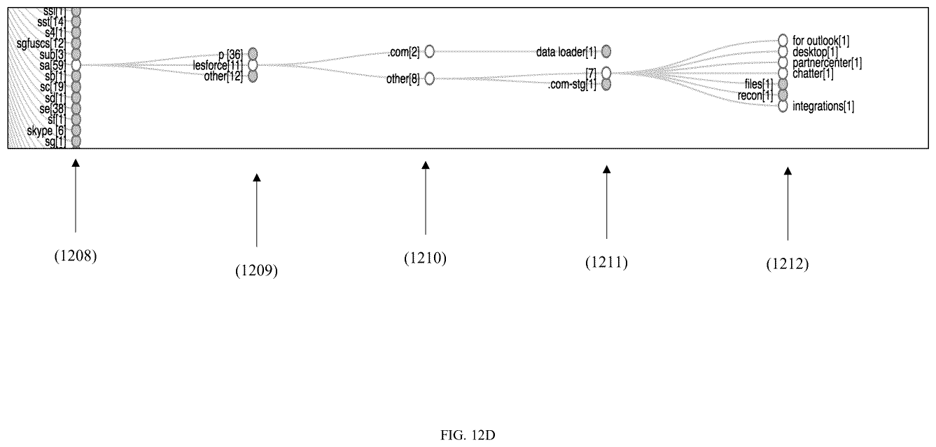

FIGS. 12A-12D show non-limiting examples of CI relationships discovery output in which a plurality of CI(s) is grouped by CI business applications and services. In the example of FIG. 12A, the plurality of CI(s) is grouped into a first plurality of CI groups 1201. For example, in FIG. 12A, the first plurality of CI groups 1201 comprises group “tib[40].” In the example of FIG. 12A, the first plurality of CI groups 1201 is grouped into a second plurality of CI groups 1202. For example, in FIG. 12A, the second plurality of CI groups 1202 comprises group “co[10].” In the example of FIG. 12A, the second plurality of CI groups 1202 are grouped into a third plurality of CI groups 1203. For example, in FIG. 12A, the third plurality of CI groups 1202 comprises group “dev[1].”

In the example of FIG. 12B, the plurality of CI(s) is grouped into a first plurality of CI groups 1204. For example, in FIG. 12B, the first plurality of CI groups 1204 comprises group “skype[6].” In the example of FIG. 12B, the first plurality of CI groups 1204 is grouped into a second plurality of CI groups 1205. For example, in FIG. 12B, the second plurality of CI groups 1205 comprises group “click to call[1].”

In the example of FIG. 12C, the plurality of CI(s) is grouped into a first plurality of CI groups 1206. For example, in FIG. 12C, the first plurality of CI groups 1206 comprises group “symantec[2].” In the example of FIG. 12C, the first plurality of CI groups 1206 is grouped into a second plurality of CI groups 1207. For example, in FIG. 12C, the second plurality of CI groups 1207 comprises group “antivirus[1].”

In the example of FIG. 12D, the plurality of CI(s) is grouped into a first plurality of CI groups 1208. For example, in FIG. 12D, the first plurality of CI groups 1208 comprises group “sa[59].” In the example of FIG. 12D, the first plurality of CI groups 1208 is grouped into a second plurality of CI groups 1209. For example, in FIG. 12D, the second plurality of CI groups 1209 comprises group “lesforce[11].” In the example of FIG. 12D, the second plurality of CI groups 1209 are grouped into a third plurality of CI groups 1210. For example, in FIG. 12D, the third plurality of CI groups 1210 comprises group “other[8].” In the example of FIG. 12D, the third plurality of CI groups 1210 are grouped into a fourth plurality of CI groups 1211. For example, in FIG. 12D, the fourth plurality of CI groups 1211 comprises group “.com-stg[1].”

In some cases, the platforms, systems, media, and methods may comprise using the CI relationships discovery module to analyze temporal correlation of customer incidents. In some instances, time-correlated customer incidents are associated with corresponding CI(s) to be time-correlated. For example, the corresponding CI(s) to be time-correlated may be indicative that said corresponding CI(s) are related.

In some cases, the CI relationships discovery module is configured to groups all CI(s) belonging to a same environment (e.g., logical isolation of CI(s) like Production, Development, QA, Staging, etc.) and analyze a temporal correlation of customer incidents.

In some instances, the temporal correlation of customer incidents is analyzed using a micro epoch. For example, the micro epoch may comprise a rolling time window in which the CI relationships discovery module tracks appearances of the customer incidents and the corresponding CI(s). In some instances, a length of the micro epoch is set to ensure that the CI relationships discovery module focuses on discovery of highly correlated customer incidents and CIs. For example, the rolling time window may comprise about 10 seconds. In further examples, the rolling time window may comprise less than 10 seconds. In even further examples, the rolling time window may comprise greater than 10 seconds.

In some instances, each time a customer incident appears, a time of the micro epoch is reset to zero. For example, the time of the micro epoch may start from a time of the last appeared correlated incident. In some instances, the micro epoch can last longer than 10 seconds if the interarrival time between consecutive customer incidents is less than the micro epoch length.

In some cases, the CI relationships discovery module further comprises a set of lens-kit temporal lens (e.g., also referred to as “temporal lens”). In some instances, the temporal lens is configured to understand the temporal behavior of an MI and MI-CG (e.g., MI Cohort Group). For example, the temporal lens may pivot on a temporal arriving time of customer incidents associated to a CI. In some instances, the temporal lens comprises a display the temporal behavior of an MI and MI-CG.

In some instances, the temporal lens comprises a CI call-back. For example, the CI call-back may comprise a dependency of CI(s) (e.g., who calls whom, discoverable within micro-epochs). In further examples, the dependency of the CI(s) may comprise the relationship between two or more CI(s). In even further examples, the dependency of the CI(s) may comprise a first CI appearing before at least one different CI.

In some cases, the temporal lens is configured to identify dominant CI(s). In some instances, a dominant CI(s) comprises a CI that appears most frequently in a given time window. In some cases, the temporal lens comprises a macro-epoch. In some instances, a macro-epoch comprises a time window where a dominant CI is active. For example, a macro-epoch may comprise the time window where a single CI continues to reappear until a different CI appears. In further examples, the macro-epoch time window comprises a start time at a beginning of a micro-epoch time window start time. In even further examples, the macro-epoch time window continues past an end time of a micro-epoch time window.

In some instances, the temporal lens is configured to discover micro-epochs. For example, a time-window characterized by customer incidents with interarrival time <+10 seconds. In further examples, the time-window is characterized by customer incidents with at least 2 distinct CIs. In some instances, a customer incident temporal correlation translates to tight or loose CI associations and dependencies. In some cases, the CI decoding module is configured to make associations with temporal dependency. In some cases, the CI decoding module is configured to discovery associations of CI(s) with hierarchical time granules.

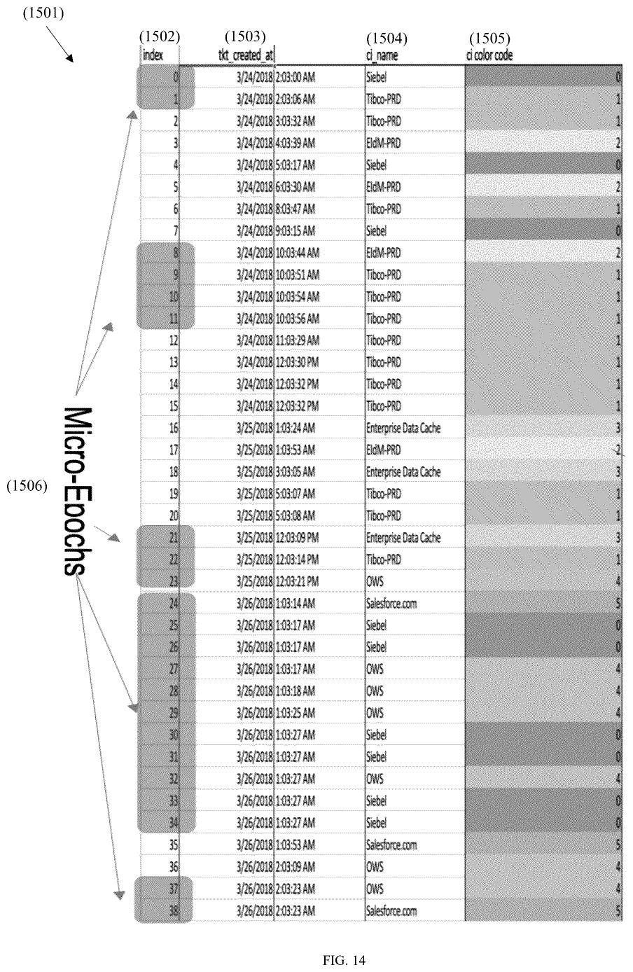

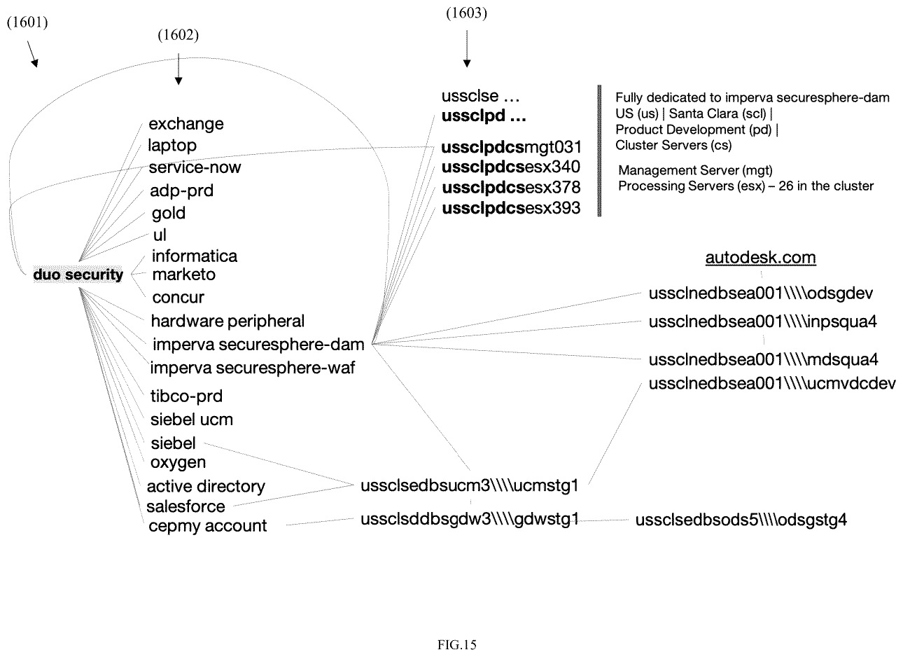

FIG. 14 shows a non-limiting example of a CI relationship discovery module, in this case, a temporal lens-MI-CG (MI Cohort Group). In the example of FIG. 14, temporal lens MI-CG 1501 is shown. In FIG. 14, the MI-CG 1501 comprises a CI index 1502, CI time stamp 1503 (e.g., date and time), CI Name 1504, and CI color code 1505. Furthermore, in FIG. 14, a micro-epoch is set with duration of 10 seconds and 5 Micro-Epoch groups 1506 are identified. For example, in FIG. 14, the temporal lens MI-CG 1501 identifies 5 periods where an interarrival time (e.g., see time stamp 1503) <=10 seconds between 2 distinct CI(s) (e.g., as identified by CI name 1504).

For example, a first of the Micro-Epoch groups comprises indices 1502 “0” and “1,” time stamp 1503 “Mar. 24, 2018 2:03:00 AM” and “Mar. 24, 2018 2:03:06 AM,” CI name 1504 “Siebel” and “Tibco-PRD” and CI color code 1505 “0” and “1” showing a first color for “0” and second color for “1.” In the example of FIG. 14, CI color code 1505 correlates to the CI Name 1504.

Furthermore, in FIG. 14, a second of the Micro-Epoch groups comprises indices 1502 “8 through 11,” time stamp 1503 “Mar. 24, 2018 10:03:44 AM through Mar. 24, 2018 10:03:56 AM,” CI name 1504 “EIDM-PRD” and “Tibco-PRD (e.g., Tibco-PRD appears three times),” and CI color codes 1505 “2” and “1” showing a first color for “2” and second color for “1 (e.g., same color for “1” as in previous micro-epoch group).”

Moreover in FIG. 14, both the CI name 1504 “Siebel” and the CI name 1504 “EIDM” comprise an interarrival time within <=10 seconds before CI name 1504 “Tibco-PRD.” Thus, in FIG. 14, the CI name 1504 “Tibco-PRD” comprises a dominant CI.

Furthermore, the CI name 1504 “Tibco-PRD” comprises a macro-epoch from a start time of the first of the Micro-Epoch groups “Mar. 24, 2018 2:03:00 AM” until a last appearance the CI name 1504 “Tibco-PRD” at “Mar. 24, 2018 12:03:32 AM.”

In some instances, the method further comprises using the CI relationships discovery module to track a direction of a relationship between time-correlated CIs. For example, if customer incident 1 (e.g., associated to CI_1) comes before the correlated customer incident 2 (e.g., associated to CI_2), CI_1 is said to cause CI_2, meaning CI_1->CI_2.

In some cases, the CI relationships discovery module may be configured to determine a CI correlation strength by computing a distribution of correlated CI pairs. In some instances, the CI Relationships discovery module computes the distribution of correlated CI pairs to identify the CIs with stronger and weaker correlation. For example, the CI relationships discovery module may comprise computing by dividing the number of total occurrences of a CI-pair to the total number of occurrences recorded (e.g., also known as CI correlation strength/dominance).

The CI relationships discovery module may be configured to provide a customer/user with visibility into CI(s) to derive operational insights about the wellness of customer infrastructure (e.g., hardware and software), systems, business services and applications.

FIG. 15 shows a non-limiting diagram of an exemplary CI discovery module relationship graph for a configuration item “duo security.”

Referring to FIG. 15, the decoder module generated CI(s) which were correlated to the CI “duo security.” For example, the generated CI(s) comprises business applications, services, compute, storage, MGM, etc. Furthermore, the decoder module generated CI(s) which were input to the CI relationships discovery module. Moreover, in the example of FIG. 15, a CI relationship graph 1601 for “Duo Security” is displayed. In FIG. 15, the CI relationship graph 1601 displays CI 1602 (e.g., within “Duo Security”). For example, the CI 1602 comprises “Imperva securesphere-dam.” In FIG. 15, the CI 1602 is related to a plurality of CI strings 1603. For example, the customer infrastructure 1602 “Imperva securesphere-dam” is related to CI string 1603 “ussclse . . . ” as well as others shown.

In FIG. 15, some of the CI(s) 1602 comprises a relationship to a same CI string 1603 as shown. For example, the customer infrastructure 1602 “Imperva securesphere-dam” and 1602 “Siebel” are both related to a same CI string 1603 “ussclsedbsucm3\\\\usmstg1.”

In FIG. 15, some of the CI strings 1603 comprise a relationship to another CI string 1603 as shown. For example, the CI string 1603 “ussclsedbsucm3\\\\usmstg1” is related to a CI string 1603 ussclnedbsea001\\\\ucmvdcdev.”

In some cases, the CI relationships discovery module may comprise automatically constructing a CI relationship graph. In some cases, the CI relationships discovery module may comprise automatically updating the CI relationship graph substantially in real-time (e.g., using CI relationships discovered by the CI relationships discovery module).

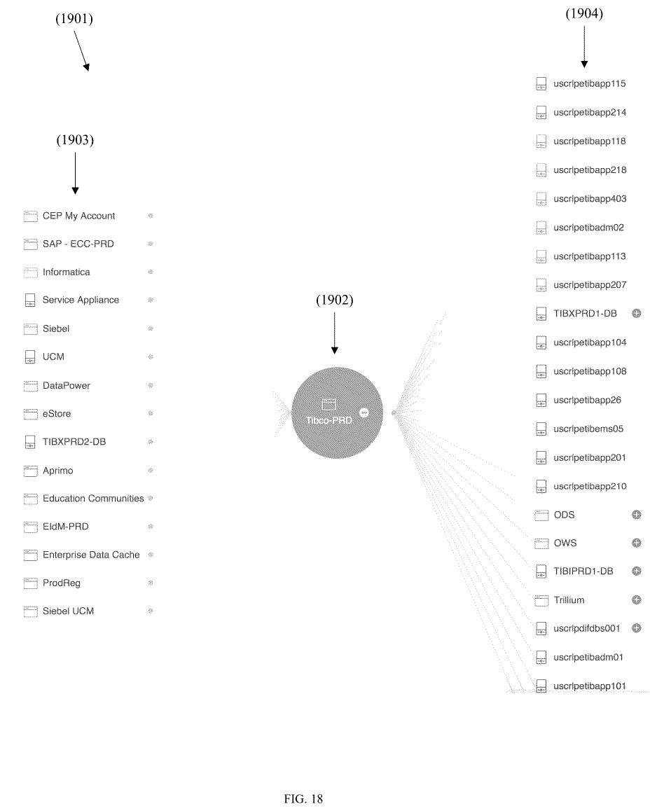

FIG. 18 shows a non-limiting diagram of an exemplary CI discovery module relationship graph, in this case, a CI relationship graph for a CI “Tibco-PRD.” In FIG. 18, the CI relationship graph 1901 is for CI 1902 “Tibco-PRD.” In the example of FIG. 18, a plurality of CI(s) 1903 are related to CI 1902 “Tibco-PRD.” For example, the CI 1903 “Siebel” is related to CI 1902 “Tibco-PRD” as shown. Furthermore, in the example of FIG. 18, a plurality of CI strings 1904 are related to CI 1902 “Tibco-PRD.” For example, the CI string 1904 “uscrlpetibapp207” is related to CI 1902 “Tibco-PRD: as shown. In some instances, the CI relationship graph for the CI comprises a selectable window. In some instances, the CI relationship graph for the CI comprises substantially all of the CI(s) and CI strings from the temporal lens (e.g., example FIG. 18 for Tibco-PRD).

In some cases, the CI relationship graph is generated at least in part via in CMDB-Assistant Module to create a CMDB-Assistant relationship graph. In some instances, the CMDB-Assistant relationship graph comprises a delta-graph. For instance, the delta-graph may comprise a plurality of correlated CI pairs. For example, in FIG. 18, the CI relationship graph 1901 for CI name 1902 “Tibco-PRD” may comprise CI names 1902 and CI strings 1903 correlated to the CI Tibco-PRD.” In some instances, the CMDB-Assistant enables the user to edit and save auto-discovered CI(s) in the CI relationship graph 1902. For example, the user may delete CI(s). In further examples, the CI discovery module may be configured to omit the deleted CI(s) from the CI relationship graph.

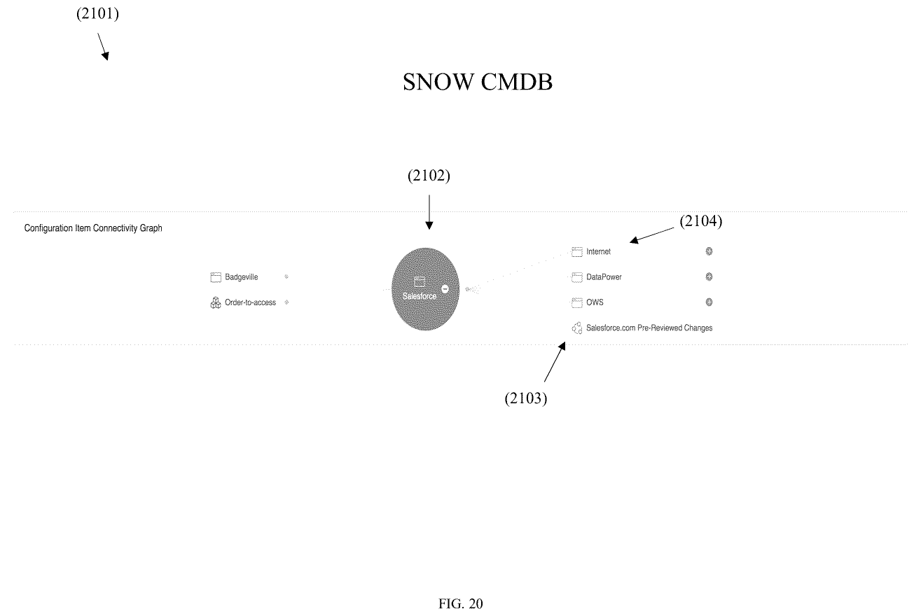

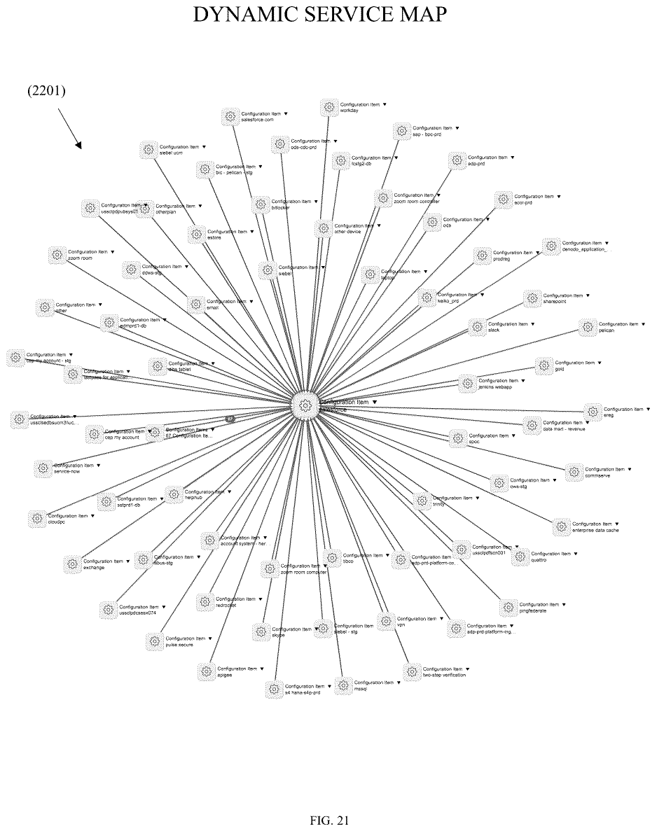

FIG. 20 shows a non-limiting diagram of an exemplary CI discovery module relationship graph, in this case, a CI relationship graph for a CI “Salesforce.” In FIG. 20, the CI relationship graph 2101 is for CI 2102 “Salesforce.” In the example of FIG. 20, a plurality of CI 2104 is related to CI 2102 “Salesforce.” For example, the CI 2104 “OWS” is related to CI 2102 “Salesforce” as shown.

In some cases, the CI relationship graph is generated at least in part via in CMDB-Assistant Module to create a CMDB-Assistant relationship graph. In some instances, the CMDB-Assistant relationship graph comprises a delta-graph. For instance, the delta-graph may comprise a plurality of correlated CI pairs. For example, in FIG. 20, the CI relationship graph 2101 for CI 2102 “Salesforce” may comprise CI names 2104 and CI strings correlated to the CI 2102 “Salesforce.”

Furthermore, in FIG. 20, the CI relationship graph displays an option 2103 “Salesforce.com Pre-reviewed changes” configured to enable the user to edit and save auto-discovered CI(s) in the CI relationship graph 2101. In some instances, the CMDB-Assistant enables the user to edit and save auto-discovered CI(s) in the CI relationship graph 2101. For example, the user may delete CI(s). In further examples, the CI discovery module may be configured to omit the deleted CI(s) from the CI relationship graph.

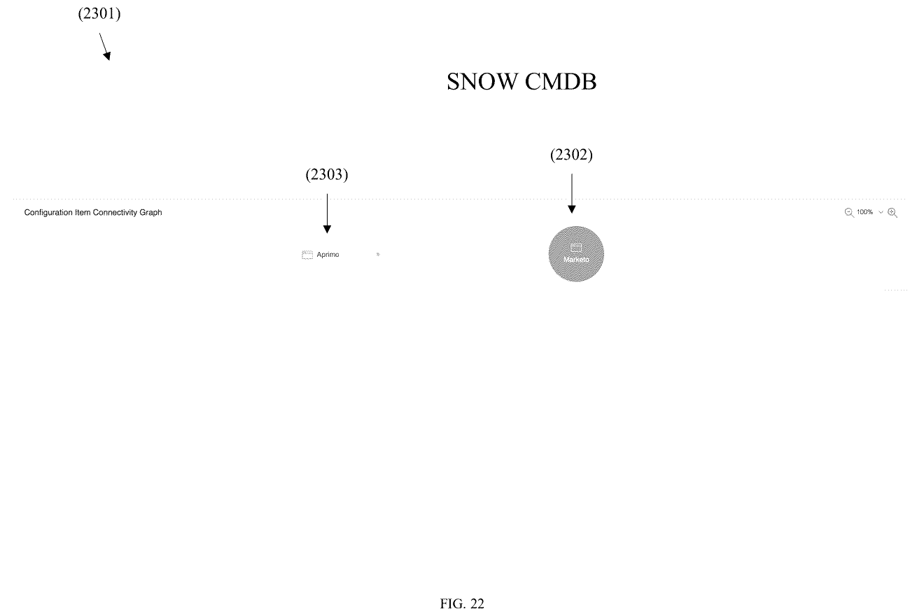

FIG. 22 shows a non-limiting diagram of an exemplary CI discovery module relationship graph, in this case, a CI relationship graph for a CI “Marketo.” In FIG. 22, the CI relationship graph 2301 is for CI 2302 “Marketo.” In the example of FIG. 22, a CI 2303 is related CI 2302 “Marketo.” For example, the CI 2302 “Aprimo” is related CI name 2302 “Marketo” as shown.

In some cases, the CI discovery module relationship graph may comprise a dynamic service map. In some instances, the dynamic service map comprises a visual representation of the relationships and dependencies of CI(s) in a customer network (e.g., a system or service). For example, the dynamic service map comprises a 1-tier dynamic service map. In further examples, the 1-tier dynamic service map comprises a visual representations of all the CI(s) related to a single CI (e.g., the single CI for which the dynamic service map was generated). In some instances, the dynamic service map is configured to be automatically constructed and enriched in real-time by the CI Relationship Discovery module. For example, the dynamic service map may be continuously constructed and enriched over a day of collecting data. In further examples, the dynamic service map may be continuously constructed and enriched over greater than a day of collecting data.

In further examples, the dynamic service map may comprise a 2-tier dynamic service map. In some instances, the 2-tier dynamic service map comprises a visual representation of the relationships and dependencies of CI(s) in a customer network (e.g., a system or service). In further examples, the 2-tier dynamic service map comprises a visual representations of all the CI(s) related to a single CI (e.g., the single CI for which the dynamic service map was generated) and of a first level of CI(s) that are related to all the CI(s) related to the single CI.

In some cases, the dynamic service map comprises a 3-tier to n-tier dynamic service map. In some instances, the 3-tier to n-tier dynamic service map comprises a visual representation of the relationships and dependencies of CI(s) in a customer network (e.g., a system or service). In further examples, the 3-tier dynamic service map comprises a visual representations of all the CI(s) related to a single CI (e.g., the single CI for which the dynamic service map was generated), of a first level of CI(s) that are related to all the CI(s) related to a single CI, and a second level of CI(s) that are related to the first level of CI(s).

In some cases, the CI relationship graph comprises a 1-tier dynamic service map. In some instances, the 1-tier dynamic service map comprises a connection score strength. For example, the connection score strength may comprise a number on the dynamic service map (e.g., 18, 24, or 36). In some instances, the connection score length comprises a the number of appearances of correlated CI pairs (e.g., within a time window). For example, a CI connection score strength of 18 indicates that the CI pairs appeared 18 times (e.g., within a time window). In some instances, the dynamic service map indicates a connection score strength by a line thickness. For example, a thicker line between a CI pair indicates a stronger connection strength (e.g., and vice-a-versa).

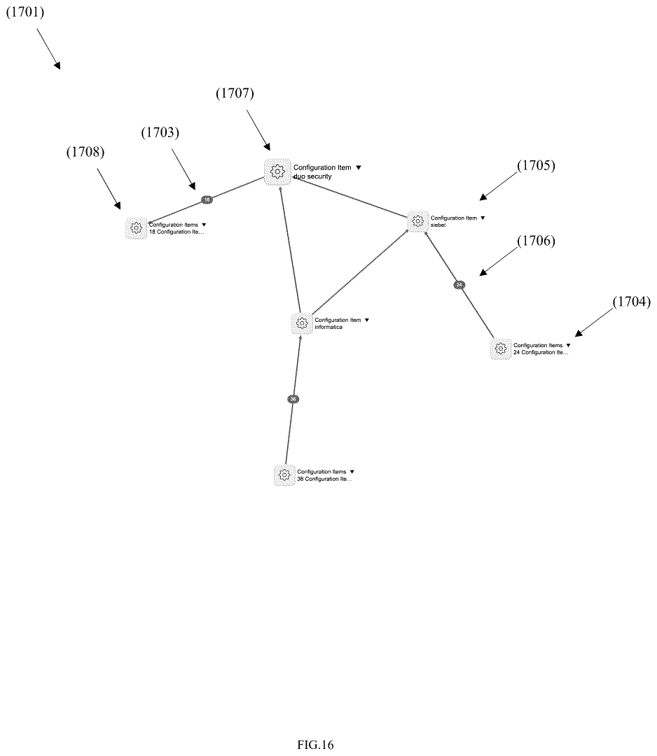

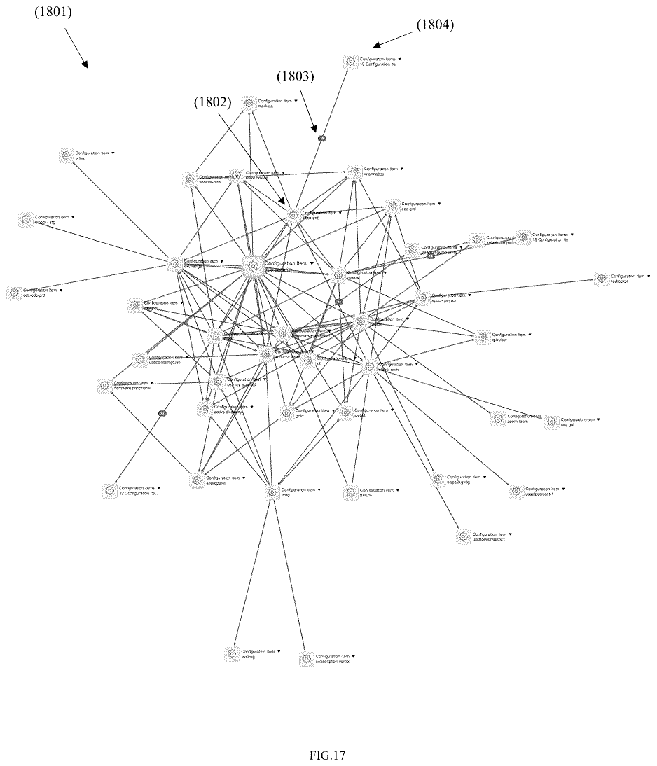

FIG. 16 shows a non-limiting diagram of an exemplary CI discovery module relationship graph comprising a 1-tier dynamic service map. In the example of FIG. 16, the dynamic service map 1701 comprises a 1-tier dynamic service map. In FIG. 16, the 1-tier Dynamic service map 1701 comprises a 1-tier Dynamic service map for the CI “Duo Security.” Referring to FIG. 16, the 1-tier Dynamic service map 1701 comprises a plurality of configuration items and a correlation strength 1703 between them. For example, in FIG. 16, configuration item 1704 has a correlation strength 1706 of “24” with configuration item 1705 “Siebel.”

Furthermore, in the example of FIG. 16, the CI relationship discovery module tracked a direction of the relationship between the plurality of CI. For example, the CI “Duo Security” 1707 comprises an arrow directed towards CI 1708. In FIG. 16, at least one customer incident associated to CI “Duo Security” 1707 (e.g., CI_1) came before at least one customer incident associated to CI 1708 (e.g., CI_2), wherein CI_1 is said to cause CI_2, meaning CI_1->CI_2.

FIG. 17 shows a non-limiting diagram of an exemplary CI discovery module relationship graph comprising a dynamic service map for the CI “Duo Security.” In the example of FIG. 17, the dynamic service map 1801 comprises a 2-tier dynamic service map. In FIG. 17, the 2-tier Dynamic service map 1801 comprises a 2-tier Dynamic service map for the CI “Duo Security.” In FIG. 17, the 2-tier dynamic service map 1801 comprises a visual representations of all the CI(s) related to the CI “Duo Security” (e.g., the single CI for which the dynamic service map was generated). Further, in FIG. 17, the 2-tier dynamic service map 1801 comprises a first level of CI(s) that are related to all the CI(s) related to the CI “Duo Security.” For example, in FIG. 17, the CI “Duo security” is related to the CI 1802 “Tibco-PRD.” Further, in FIG. 17, the first level of CI(s) comprises “Tibco-PRD.” Moreover, in FIG. 17, the first level displays all the relationships to first level CI(s). For example, in FIG. 17, the CI 1802 “Tibco-PRD” is related to a plurality of first levels CI(s) (e.g., beyond CI “Duo Security” including a CI 1804, a CI “informatica,” etc. Furthermore, in FIG. 17 the plurality of first level CI(s) are not directly related to the CI “Duo Security.” For example, the CI “informatica” is related to the CI 1802 “Tibco-PRD” wherein the CI 1802 “Tibco-PRD” is related to the CI “Duo Security” (e.g., the plurality of first level CI(s) are one level away from “the CI “Duo Security”).

Referring to FIG. 17, the 2-tier Dynamic service map 1801 comprises a plurality of configuration items and a correlation strength 1803 between them. For example, in FIG. 17, configuration item “Tibco-PRD” 1802 has a correlation strength 1803 of “19” with configuration item 1804.

Furthermore, in the example of FIG. 17, the CI relationship discovery module tracked a direction of the relationship between a plurality of CI(s). For example, the CI “Tibco-PRD” 1802 comprises an arrow directed towards CI 1804. In FIG. 17, at least one customer incident associated to CI “Tibco-PRD” 1802 (e.g., CI_1) came before at least one customer incident associated to CI group 1804 (e.g., CI_2), wherein CI_1 is said to cause CI_2, meaning CI_1->CI_2.

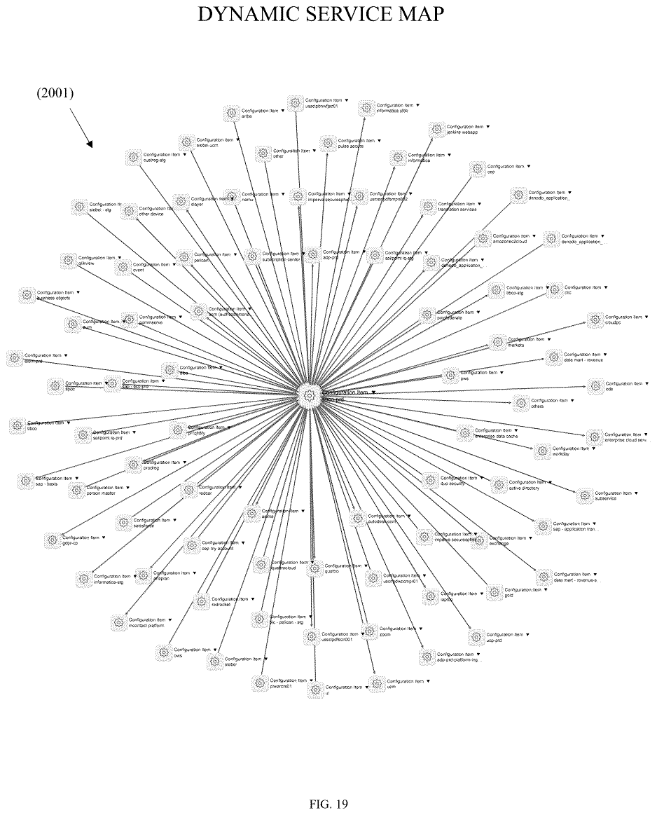

FIG. 19 shows a non-limiting diagram of an exemplary CI discovery module relationship graph comprising a 1-tier dynamic service map for configuration item “Tibco-PRD.” In the example of FIG. 19, the dynamic service map 2001 comprises a 1-tier dynamic service map. In FIG. 19, the 1-tier Dynamic service map 2001 comprises a 1-tier Dynamic service map for the configuration item “Tibco-PRD.” Referring to FIG. 19, the 1-tier Dynamic service map 2001 comprises a plurality of CI(s) and a correlation strength between them.

Furthermore, in the example of FIG. 19, the CI relationship discovery module tracked a direction of the relationship between a plurality of CI(s). For example, the CI “tibco-prd” comprises an arrow directed towards a plurality of other CI(s) (e.g., such as CI “ods”). For example, in FIG. 19, at least one customer incident associated to CI “tibco-prd” (e.g., CI_1) came before at least one customer incident associated to CI “ods” (e.g., CI_2), wherein CI_1 is said to cause CI_2, meaning CI_1->CI_2.

FIG. 21 shows a non-limiting diagram of an exemplary CI discovery module relationship graph, in this case, a dynamic service map for a CI “Salesforce.” In the example of FIG. 21, the dynamic service map 2201 comprises a 1-tier dynamic service map. In FIG. 21, the 1-tier Dynamic service map 2201 comprises a 1-tier Dynamic service map for the CI “Salesforce.” Referring to FIG. 21, the 1-tier Dynamic service map 2201 comprises a plurality of CI(s) and a correlation strength between them.

Furthermore, in the example of FIG. 21, the CI relationship discovery module tracked a direction of the relationship between the plurality of CI(s). For example, the CI “Salesforce” comprises an arrow directed towards a plurality of other CI(s) (e.g., such as CI “ods”). For example, in FIG. 21, at least one customer incident associated to CI group “tibco-prd” (e.g., CI_1) came before at least one customer incident associated to CI group “ods” (e.g., CI_2), wherein CI_1 is said to cause CI_2, meaning CI_1->CI_2.

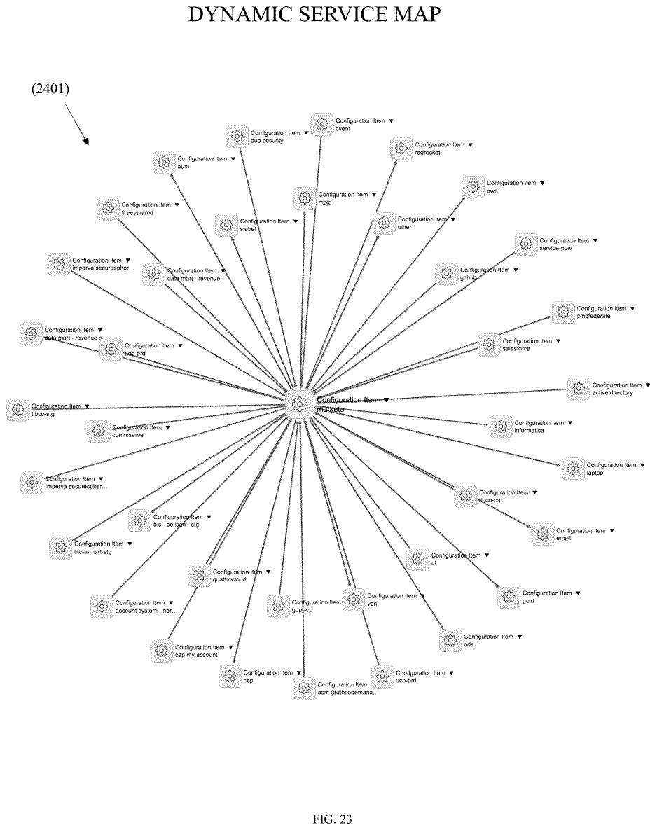

FIG. 23 shows a non-limiting diagram of an exemplary CI discovery module relationship graph, in this case, a dynamic service map. In the example of FIG. 23, the dynamic service map 2401 comprises a 1-tier dynamic service map. In FIG. 23, the 1-tier Dynamic service map 2401 comprises a 1-tier Dynamic service map for the CI “Marketo.” Referring to FIG. 21, the 1-tier Dynamic service map 2201 comprises a plurality of CI(s) and a correlation strength between them.

Furthermore, in the example of FIG. 23, the CI relationship discovery module tracked a direction of the relationship between the plurality of CI(s). For example, the CI “Marketo” comprises an arrow directed towards a plurality of other CI (e.g., such as CI “ods”). For example, in FIG. 23, at least one customer incident associated to CI “Marketo” (e.g., CI_1) came before at least one customer incident associated to CI “ods” (e.g., CI_2), wherein CI_1 is said to cause CI_2, meaning CI_1->CI_2.

In some embodiments, the platforms, systems, media, and methods disclosed herein may comprise a modality of operation. In some cases, the modality of operation may comprise a self-operating modality. In some instances, the self-operating modality may comprise loading customer incidents into the CI decoder module and decoding CI(s) and dynamic attributes. In some instances, the self-operating modality may be configured to display a graph to a user. In some instances, the graph may comprise a CI relationship graph. For example, the CI relationship graph may be configured to dynamically display CI(s) discovered by the CI relationship discovery module (e.g., as they are discovered they are added to the graph).

In some cases, the modality of operation may comprise a CMDB-assisted modality. In some instances, the CMDB-assisted modality may comprise loading customer incidents into the CI decoder module and decoding CI(s) and dynamic attributes. In some instances, the CMDB-assisted modality may be configured to display a graph to a user. In some instances, the graph may comprise a CI relationship graph. For example, the CI relationship graph may be configured to dynamically display CI(s) discovered by the CI relationship discovery module (e.g., as they are discovered they are added to the graph).

In some instances, the CMDB assisted modality may be configured to enable the user to edit and save auto-discovered CI(s) in the CI relationship graph. For example, the user may delete CI(s). In some instances, the CI discovery module may be configured to omit the deleted CI(s) from the CI relationship graph.

In some instances, the CMDB assisted modality may be configured to learn delta. For example, the CI relationship graph will not display the CI(s) related to the deleted CI(s). In further examples, the CI relationship graph may comprise a visual representations of the delta CI(s) (e.g., CI(s) outside the scope of the deleted CI and the CI(s) correlated to the deleted CI). In some instances, the CMDB assisted modality may comprise exposing a delta-graph to user. In some instances, the CMDB assisted modality may comprise allowing the user to edit & save auto-discovered CIs in the delta-graph.

In some cases, the CI(s) comprising a customer network are stored in a CI databased called CMDB (Configuration Item Management Database). In some instances, the CMDB is updated at regular intervals and tracks the CIs, and their relationships change over time (e.g., device addition, deletion, migration, etc.).

In some instances, the CMDB comprises a centralized repository that stores information about a plurality of configuration items (CIs) within an IT environment. For example, CI(s) may comprise hardware, software, documentation, personnel, and other elements that make up an IT system. In some instances, the CMDB is configured to track and manage CI(s), CI relationships, and changes in CI(s) over time. For example, the CMDB may be configured to understand dependencies between different components of an IT infrastructure.

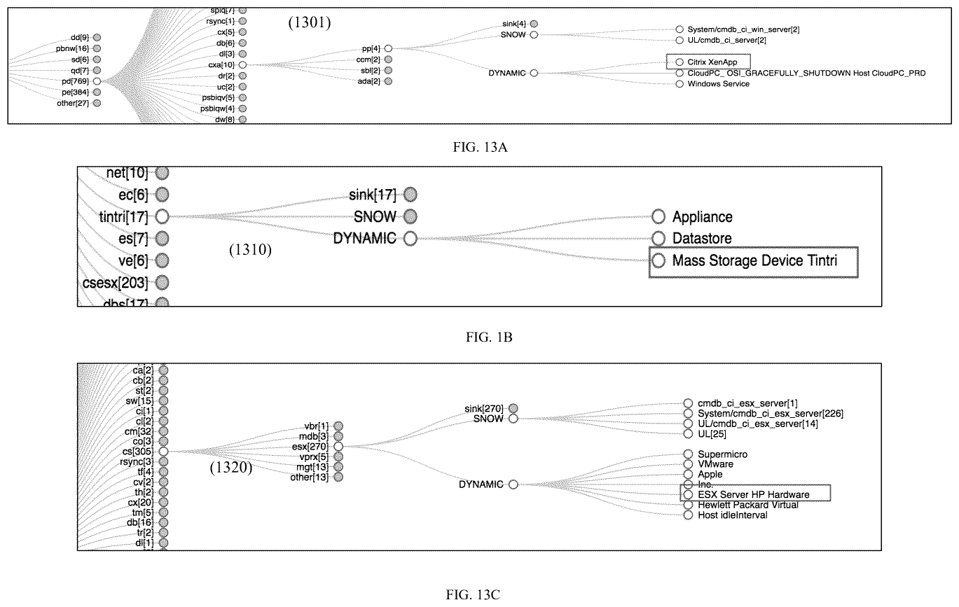

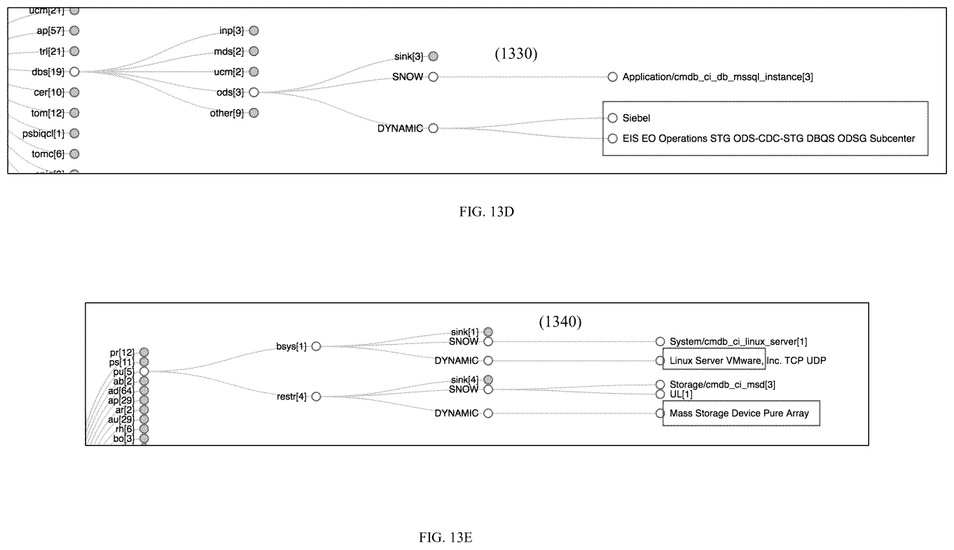

FIGS. 13A-13E show non-limiting examples of CI relationships discovery output in which a plurality of CI(s) is grouped by a self-operating CI decoder and a CMDB-assisted CI decoder.

In the example of FIG. 13A, a plurality of CI groups 1301 is displayed. For example, in FIG. 13A, the SNOW decoder extracts 2 attributes from “pp[4]” and the dynamic decoder extracts 3 attributes from “pp[4].”

In the example of FIG. 13B, a plurality of CI groups 1310 is displayed. In the example of FIG. 13B, the SNOW decoder extracts 0 attributes from “tintri[17]” and the dynamic decoder extracts 3 attributes from “tintri[17].”

In the example of FIG. 13C, a plurality of CI groups 1320 is displayed. In the example of FIG. 13C, the SNOW decoder extracts 4 attributes from “esx[270]” and the dynamic decoder extracts 7 attributes from ““esx[270].”

In the example of FIG. 13D, a plurality of CI groups 1330 is displayed. In the example of FIG. 13D, the SNOW decoder extracts 1 attributes from “ods[3]” and the dynamic decoder extracts 2 attributes from “ods[3].”

In the example of FIG. 13E, a plurality of CI groups 1340 is displayed. In the example of FIG. 13E, the SNOW decoder extracts 1 attributes from “bsys[1]” and the dynamic decoder extracts 1 attributes from “bsys[1].” Also, In the example of FIG. 13E, the SNOW decoder extracts 2 attributes from “restr[4]” and the dynamic decoder extracts 1 attributes from “restr[4].”

### EXAMPLES

The following illustrative examples are representative of embodiments of the software applications, systems, and methods described herein and are not meant to be limiting in any way.

### Example 1—Configuration Item Decoder LLM Prompt

The following is an exemplary prompt for a configuration item decoder LLM:
######CI DECODER-PROMPT START ######

I am giving you an encoded Configuration Item (CI) string which encodes the CI Region, Environment, Name, and instance. Typically, the Region is encoded with 2-3 letters for the Country and 2-3 letters for the city. The Region code is followed by 2-5 letters for the Environment. This is followed by the CI name which can be encoded with a variable number of letters reflecting the hardware or software asset. Last is the instance which can be present or not and typically is encoded with 2-3 numbers. Process my CI encoded string $encodedCI and save your JSON-formatted output in $decodedJSON:

{
“Region”: string,
“Country”:string,
“City”: string,
“Environment”:string,
“Name”:string,
:Instance”:string
}

I would like you to infer those attributes based on your reasoning. For example, from a CI string like “ussclpdpurestr001” you would report: Region: USSCL, Country: US (US), City: Santa Clara (SCL), Environment: Production (PD), Name: Pure Storage (PURESTR): Instance: 001 (001).

The CI encoded string $encodedCI is “XXX”. My $decodedJSON is:
######CI DECODER-PROMPT END ######

### Example 2—Configuration Item Decoder

The following is an example of using the CI decoder LLM to decipher the CI encoded string and extract the CI attributes:
Input: The CI encoded string is “inpundevtib002”.
Output. The $outputJSON is:

{
“Region”: “INPUN”,
“Country”: “India (IN)”,
“City”: “Pune (PUN)”,
“Environment”: “Development (DEV)”,
“Name”: “Tibco (TIB)”,
“Instance”: “002”
}

### Example 3—Configuration Item Decoder

The following is an example of using the CI decoder LLM to decipher the CI encoded string and extract the CI attributes:
Input: The CI encoded string is “usbosdeopscenter002”.
Output. The $outputJSON is:

{
“Region”: “USBOS”,
“Country”: “USA”,
“City”: “Boston”,
“Environment”: “Development”,
“Name”: “OpsCenter”,
“Instance”: “002”
}

### Example 4—Configuration Item Decoder

The following is an example of using the CI decoder LLM to decipher the CI encoded string and extract the CI attributes:
Input: The CI encoded string is “cnhoncsskype004”.
Output. The $outputJSON is:

{
“Region”: “CNHON”,
“Country”: “China (CN)”,
“City”: “Hong Kong (HON)”,
“Environment”: “Customer Service (CS)”,
“Name”: “Skype (SKYPE)”,
“Instance”: “004”
}

### Example 5—Configuration Item Decoder

The following is an example of using the CI decoder LLM to decipher the CI encoded string and extract the CI attributes:
Input: The CI encoded string is “usporstgsfdc002”.
Output. The $outputJSON is:

{
“Region”: “USPOR”,
“Country”: “USA”,
“City”: “Portland”,
“Environment”: “Staging”,
“Name”: “Salesforce”,
“Instance”: “002”
}

### Example 6—Configuration Item Decoder

The following is an example of using the CI decoder LLM to decipher the CI encoded string and extract the CI attributes:
Input: The CI encoded string is “usporstgdynamicmassstoragedevicepurearray”.
Output. The $outputJSON is:

{
“Region”: “USPOR”,
“Country”: “USA”,
“City”: “Portland”,
“Environment”: “Staging”,
“Name”: “Dynamic Mass Storage Device Pure Array”,
“Instance”: “”
}

### Example 7—Configuration Item Relationships Discovery Module

The following is an example of a CI relationship discovery module GUI:

FIG. 14 shows a non-limiting example of a CI relationship discovery module comprising a temporal lens-MI-CG (Major Incident Cohort Group).

In a specific embodiment, the temporal lens MI-CG module processed all the incidents from Mar. 24, 2018 @2:03:00 AM till Mar. 26, 2008 @ 2:03:23 AM for the PRODUCTION environment (PRD). A micro epoch set with duration of 10 seconds was used. The CI relationships discovery module found 5 micro epochs where incidents were correlated (e.g., rectangles on the bottom).

In FIG. 14, the temporal lens MI-CG processed customer incidents recollected over 2 days' time frame. As shown, the CI Relationship Discovery module started with a first micro-epoch at 2:03:00 am and found within the 10 seconds two correlated CIs: Siebel->Tibco. No other CIs were found between 2:03:06 and 2:03:16 and hence the first micro-epoch was closed. A second micro-epoch started at 10:03:44 because it found EIDM to be correlated to Tibco (10:03:44 am and 10:03:51 AM). The second micro-epoch kept extending until 10:03:56 because it received other incidents related to Tibco and it officially closed at 10:03:56 am. The temporal lens MI-CG module continued to process customer incidents after the second micro-epoch closed. After processing the entire data set, the CI Relationship Discovery module has discovered the following CI relationships:
Siebel->Tibco
EIDM->Tibco
Enterprise Data Cache->Tibco
Tibco->OWS
Salesforce->Siebel
Siebel->OWS
OWS->Siebel
OWS->Salesforce

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

What is claimed is:

1. A computer-implemented method for deriving operational insights about customer infrastructure, the method comprising:
(a) obtaining customer incident data reported by one or more customers, wherein the customer incident data is pre-encoded using one or more encoding techniques that are specific or unique to the one or more customers; and
(b) using a decoder module to directly process the customer incident data to generate an output, wherein the output comprises a plurality of configuration items (CIs) discovered, derived, or extracted from the customer incident data.

2. The method of claim 1, wherein the decoder module does not require processing of other data to generate the output comprising of the plurality of CIs.

3. The method of claim 1, wherein the customer incident data is pre-encoded in a form of a configuration item (CI) string.

4. The method of claim 3, wherein the CI string comprises a CI name and a set of CI attributes.

5. The method of claim 4, wherein the set of CI attributes comprises a region, an environment, a type and/or an instance identifier associated with the CI.

6. The method of claim 5, wherein the plurality of CIs in the output of the decoder module comprises the CI name and the set of CI attributes discovered, derived or extracted from the CI string.

7. The method of claim 1, wherein the decoder module uses n-gram based string decoding using algebraic signatures to directly process the customer incident data.

8. The method of claim 6, further comprising:
(c) using a CI relationships discovery module to group the plurality of CIs based at least in part on the environment(s) in which the CIs are deployed.

9. The method of claim 6, wherein the CIs belonging to a same environment are grouped together to allow logical isolation of the plurality of CIs.

10. The method of claim 6, further comprising using the CI relationships discovery module to analyze temporal correlation of customer incidents, wherein time-correlated customer incidents are associated with corresponding CIs to be time-correlated.

11. The method of claim 10, wherein the corresponding CIs to be time-correlated are indicative that said corresponding CIs are related.

12. The method of claim 10, wherein the temporal correlation of customer incidents is analyzed using a micro epoch, wherein the micro epoch comprises a rolling time window in which the CI relationships discovery module tracks appearances of the customer incidents and the corresponding CIs.

13. The method of claim 10, wherein the rolling time window is about 10 seconds.

14. The method of claim 12, wherein a length of the micro epoch is set to ensure that the CI relationships discovery module focuses on discovery of highly correlated customer incidents and CIs.

15. The method of claim 12, further using the CI relationships discovery module to track a direction of a relationship between time-correlated CIs.

16. The method of claim 14, wherein the CI relationships discovery module is used to determine a CI correlation strength by computing a distribution of correlated CI pairs.

17. The method of claim 15, further comprising: automatically constructing a CI relationship graph and updating the CI relationship graph substantially in real-time using CI relationships discovered by the CI relationships discovery module.

18. A computer-implemented system comprising at least one processor and instructions causing the at least one processor to perform operations for deriving operational insights about customer infrastructure, the system comprising: a decoder module configured to directly process customer incident data to generate an output, wherein the customer incident data is reported by one or more customers and is pre-encoded using one or more encoding techniques that are specific or unique to the one or more customers, and wherein the output comprises a plurality of configuration items (CIs) discovered, derived, or extracted from the customer incident data.

19. One or more non-transitory computer-readable storage media encoded with instructions executable by one or more processors to provide an application for deriving operational insights about customer infrastructure, the application comprising:
(a) a software module obtaining customer incident data reported by one or more customers, wherein the customer incident data is pre-encoded using one or more encoding techniques that are specific or unique to the one or more customers; and
(b) a software module using a decoder to directly process the customer incident data to generate an output, wherein the output comprises a plurality of configuration items (CIs) discovered, derived, or extracted from the customer incident data.
